(19) United States
(12) Patent Application Publication
(10) Pub. No.: US 2013/0233707 A1
(43) Pub. Date: Sep. 12, 2013

(54) SENSOR AND SENSOR SYSTEM

(71) Applicant: AISAN KOGYO KABUSHIKI KAISHA, Aichi-ken (JP)

(72) Inventors: Nobuhiro Kato, Aichi-ken (JP); Masaki Ikeya, Aichi-ken (JP)

(73) Assignee: AISAN KOGYO KABUSHIKI KAISHA, Aichi-ken (JP)

(21) Appl. No.: 13/789,646

(22) Filed: Mar. 7, 2013

(30) Foreign Application Priority Data
Mar. 9, 2012 (JP) 2012-052495
Mar. 30, 2012 (JP) 2012-078757
Mar. 30, 2012 (JP) 2012-082173

(51) Int. Cl. G01N 27/27

(52) U.S. Cl. CPC G01N 27/27
USPC 204/406; 204/412; 204/407

(57) ABSTRACT

A sensor for detecting the property of the liquid includes a substrate, a first pair of electrodes disposed on an upper surface of the substrate, and a second pair of electrodes disposed on a lower surface of the substrate. A capacitance of the first pair of electrodes and a capacitance of the second pair of electrodes mutually change correlatively to the same property of the liquid.

### CROSS-REFERENCE TO RELATED APPLICATIONS

This application claims priority to Japanese Patent Application No. 2012-078757 filed on Mar. 30, 2012, Japanese Patent Application No. 2012-052495 filed on Mar. 9, 2012, and Japanese Patent Application No. 2012-082173 filed on Mar. 30, 2012, the contents of which are hereby incorporated by reference into the present application.

### TECHNICAL FIELD

The specification discloses a technique for appropriately detecting a property of liquid.

### DESCRIPTION OF RELATED ART

A technique is known which utilizes a change in a capacitance of a pair of electrodes to detect a property of liquid. For example, Japanese Patent Application Publication No. 2005-351688 discloses a liquid level and quality sensor with a pairs of electrode disposed on each of an upper surface and a lower surface of a substrate. The capacitance of the pair of electrodes disposed on the upper surface of the substrate changes correlatively to a level of engine oil. The capacitance of the pair of electrodes disposed on the lower surface of the substrate changes correlatively to quality of the engine oil but not to the level of the engine oil. The liquid level and quality sensor in Japanese Patent Application Publication No. 2005-351688 detects the level of the engine oil based on a change in the capacitance of the pair of electrodes disposed on the upper surface of the substrate, and detects the quality of the engine oil based on a change in the capacitance of the pair of electrodes disposed on the lower surface of the substrate.

### SUMMARY

The liquid level and quality sensor in Japanese Patent Application Publication No. 2005-351688 may fail to appropriately detect a property of a detection target liquid depending on a detection target liquid. For example, when the capacitance changes insignificantly in response to a change in the quality of the detection target liquid, the sensor may fail to appropriately detect the quality. Furthermore, when the capacitance changes insignificantly in response to a change in the level of the detection target liquid, the sensor may fail to appropriately detect the level. The specification provides a technique for appropriately detecting the property of the liquid using the pair of electrodes.

The technique disclosed herein is a sensor for detecting a property of liquid. A first sensor disclosed herein includes a substrate, a first pair of electrodes, and a second pair of electrodes. The first pair of electrodes is disposed on an upper surface of the substrate. The second pair of electrodes is disposed on a lower surface of the substrate. A capacitance of the first pair of electrodes and a capacitance of the second pair of electrodes mutually change correlatively to a same property of the liquid.

Compared to the conventional configuration in which a pair of electrodes having a capacitance changing correlatively to one property of liquid is disposed only on an upper surface of a substrate, the above-described first sensor can increase an amount of change in a capacitance of the sensor (that is, the first and second pairs of electrodes) with respect to an amount of change in the property of the liquid. That is, a sensitivity of the sensor to the change in the property of the liquid can be increased. As a result, compared to the conventional configuration, the first sensor can be used to appropriately detect the property of the liquid.

A second sensor disclosed herein includes a substrate, a sensor unit including a substrate, a first pair of electrodes with a first electrode and a second electrode disposed on an upper surface of the substrate apart from each other, and a second pair of electrodes with a third electrode and a fourth electrode disposed on a lower surface of the substrate apart from each other, and a connection unit configured to connect a power source and the sensor unit. In the sensor, the first electrode opposes at least a part of the third electrode via the substrate, and the second electrode opposes at least a part of the fourth electrode via the substrate. The connection unit can connect the electrodes in a state in which both the first electrode and the fourth electrode are at a first electric potential and both the second electrode and the third electrode are at a second electric potential different from the first electric potential.

In the second sensor, the connection unit connects the power source to the first electrode, the second electrode, the third electrode, and the fourth electrode in the state in which both the first electrode and the fourth electrode are at the first electric potential and both the second electrode and the third electrode are at the second electric potential different from the first electric potential. Thus, a potential difference occurs between the opposite electrodes (between the first electrode and the second electrode, and between the third electrode and the fourth electrode, respectively) on the same surface (respectively on the upper surface and the lower surface) of the substrate. A potential difference also occurs between the electrodes (between the first electrode and the third electrode and between the second electrode and the fourth electrode) at least partly opposite to each other with the substrate in between. As a result, a capacitive component (a capacitance of the capacitive component is denoted by Cz) between the electrodes at least partly opposite to each other with the substrate in between is connected in parallel with a capacitive component (a capacitance of the capacitive component is denoted by Cy) between the opposite electrodes on the surface of the substrate, and a capacitance C of the sensor unit is such that C=Cy+Cz. A dielectric loss tan δ of the sensor unit is expressed by Expression (1) shown below, using an angular frequency ω of the power source, a parasitic resistance R2 of the sensor unit (which is affected by an electric conductivity of the liquid), and the capacitance C. Expression (1) indicates that when the capacitance C increases by Cz, the dielectric loss tan δ decreases, enabling an adverse effect of the electric conductivity of the liquid to be reduced.

tan δ=1/ωCR2 (1)

### BRIEF DESCRIPTION OF DRAWINGS

FIG. 1 shows a configuration of a sensor system according to a first embodiment.

FIG. 2 shows a configuration of a sensor system according to a second embodiment.

FIG. 3 shows a configuration of a sensor system according to a third embodiment.

FIG. 4 schematically shows a sensor system according to a fourth embodiment.

FIG. 5 is a cross-sectional view of the sensor system in FIG. 4 taken along line V-V in FIG. 4.

FIG. 6 schematically shows a sensor system according to a variation.

FIG. 7 schematically shows a sensor system according to a fifth embodiment.

FIG. 8 schematically shows a sensor system according to a variation.

FIG. 9 schematically shows a sensor system according to a sixth embodiment.

FIG. 10 schematically shows a sensor system according to a variation.

FIG. 11 shows a relation between a first output and an ethanol concentration of a mixed fuel.

FIG. 12 shows a relation between a second output and an electric conductivity of the mixed fuel.

FIG. 13 shows a relation between a second output and the ethanol concentration of the mixed fuel.

### DETAILED DESCRIPTION OF EMBODIMENT

In a first sensor disclosed herein, a first pair of electrodes may include a first signal electrode to which a signal is input from outside and a first reference electrode opposing the first signal electrode with a space in between. A second pair of electrodes may include a second signal electrode to which a signal is input from outside and a second reference electrode opposing the second signal electrode with a space in between. The first signal electrode and the second signal electrode may have a same shape. The first reference electrode and the second reference electrode may have a same shape. A distance between the first signal electrode and the first reference electrode may be equal to a distance between the second signal electrode and the second reference electrode. This configuration can make a capacitance of the first pair of electrodes equal to a capacitance of the second pair of electrodes.

In the first sensor, the capacitance of the first pair of electrodes and the capacitance of the second pair of electrodes may mutually change correlatively to a concentration of a specific material included in liquid. This configuration can appropriately detect the concentration of the specific material included in the liquid.

The specification further discloses a sensor system including the first sensor. The sensor system may include the first sensor, a signal supplying device, and a comparing device. The signal supplying device may supply a signal to the first pair of electrodes and the second pair of electrodes. The comparing device may compare a first correlation value correlated to the capacitance of the first pair of electrodes during when the signal supplying device is supplying the signal to the first pair of electrodes and a second correlation value correlated to the capacitance of the second pair of electrodes during when the signal supplying device is supplying the signal to the second pair of electrodes, and to output a comparison result.

The first correlation value and the second correlation value are correlated to a same property. Thus, the first correlation value and the second correlation value are positively correlated to each other. However, if one of the first pair of electrodes and the second pair of electrodes is damaged or a foreign substance is attached to one of the first pair of electrodes and the second pair of electrodes, the capacitance of the one of the pairs of electrodes may be changed by a factor different from the property of the liquid. In this case, the correlation between the first correlation value and the second correlation value is disrupted, reducing a correlation coefficient for the correlation values. This relation enables determination of whether one of the first correlation value and the second correlation value fails to be correlated to the property of the liquid, using the comparison result output by the comparing device. Thus, the property of the liquid can be prevented from being detected using the correlation value not correlated to the property of the liquid.

In the sensor system, the first pair of electrodes may be connectable to the second pair of electrodes in parallel. This configuration enables the capacitance of the sensor to be increased compared to a configuration in which the first pair of electrodes and the second pair of electrodes are connected in series.

The specification further discloses another sensor system including the first sensor. The sensor system may include the first sensor and a specifying device connected to the first sensor and configured to specify a property of liquid based on a signal output from the first sensor. The specifying device may include a signal supplying unit configured to supply a signal to the first sensor, a reference equivalent circuit including one or more reference elements corresponding to an equivalent circuit of the first sensor, and an arithmetic unit configured to correct the signal output from the first sensor based on a signal output from the reference equivalent circuit when the signal is fed from the signal supplying unit to the reference equivalent circuit. This configuration corrects the signal output from the first sensor using the reference elements, allowing a variation in detection accuracy among sensor systems to be suppressed.

The specifying device may further include a power voltage measurement unit configured to measure a voltage of power supplied to the first sensor and the signal supplying unit, and a temperature measurement unit configured to measure a temperature of the specifying device. The arithmetic unit may further be configured to correct the signal output from the first sensor based on the voltage of power measured by the power voltage measurement unit and the temperature measured by the temperature measurement unit. This configuration can restrain the signal output from the first sensor from being changed by a change in the temperature of the specifying device or in the voltage of power supplied to the first sensor.

In a second sensor disclosed herein, the first electrode may oppose the third electrode via the substrate, and the second electrode may oppose the fourth electrode via the substrate.

In the second sensor, the connection unit may further include a switching device configured to switch between a state in which both the first electrode and the fourth electrode are at the first electric potential and both the second electrode and the third electrode are at the second electric potential, and a state in which both the first electrode and the third electrode are at the first electric potential and both the second electrode and the fourth electrode are at the second electric potential.

In the second sensor, the connection unit may include a switching device configured to switch between a state in which the first pair of electrodes and the second pair of electrodes are connected in parallel and a state in which the first pair of electrodes and the second pair of electrodes are connected in series.

The specification provides a method for measuring a property of liquid using a sensor including a substrate, a first pair of electrodes including a first electrode and a second electrode disposed on an upper surface of the substrate apart from each other, and a second pair of electrodes including a third electrode and a fourth electrode disposed on a lower surface of the substrate apart from each other, wherein the first electrode opposes at least a part of the third electrode via the substrate, and the second electrode opposes at least a part of the fourth electrode via the substrate. The method supplies power to the sensor in such a manner that both the first electrode and the fourth electrode are at a first electric potential and both the second electrode and the third electrode are at a second electric potential different from the first electric potential, and measures a capacitance of the liquid using a first output from the sensor.

The method for measuring the property of the liquid may further include supplying power to the sensor in such a manner that both the first electrode and the third electrode are at the first electric potential and both the second electrode and the fourth electrode are at the second electric potential, and calculating an electric conductivity of the liquid based on a second output and the first output from the sensor.

According to the method for measuring the property of the liquid, the capacitance and electric conductivity of the liquid may be measured using an output from the sensor obtained when power is supplied to the sensor in a state in which the first pair of electrodes and the second pair of electrodes are connected in parallel and an output from the sensor obtained when power is supplied to the sensor in a state in which the first pair of electrodes and the second pair of electrodes are connected in series.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved sensors and sensor systems, as well as methods for using the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

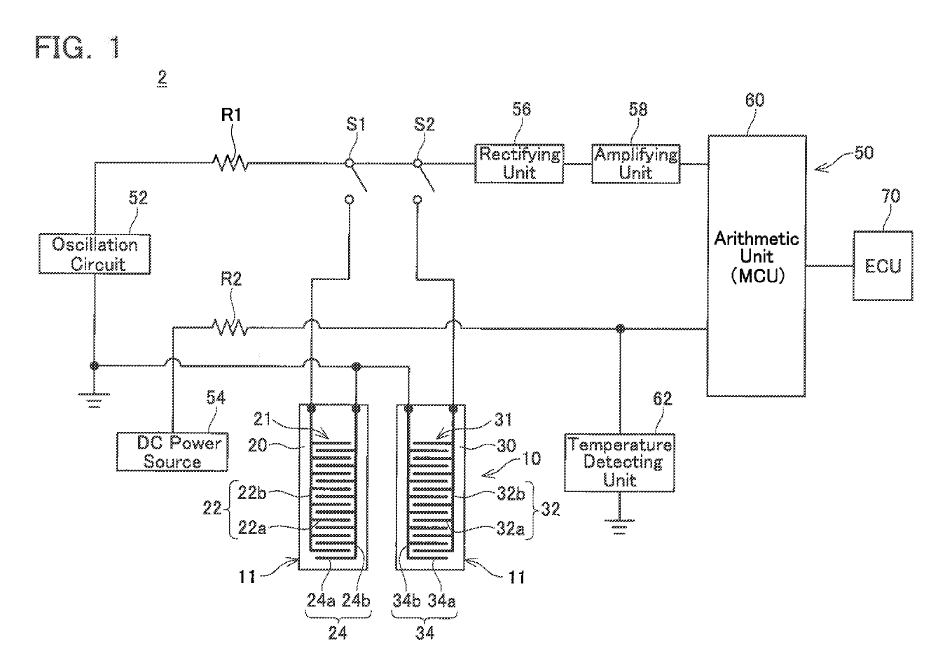

A sensor system 2 is mounted in an automobile using a mixed fuel of gasoline and ethanol as a fuel. The sensor system 2 is used to detect a concentration of ethanol in the mixed fuel. As shown in FIG. 1 the sensor system 2 includes a sensor 10 and a specifying device 50.

The sensor 10 includes a substrate 11 and two pairs of electrodes 21 and 31. FIG. 1 shows an upper surface 20 and a lower surface 30 of the substrate 11 juxtaposed with each other. In actuality, the sensor 10 includes the single substrate 11.

The pair of electrodes 21 is disposed on the upper surface 20 of the substrate 11. The pair of electrodes 21 includes a signal electrode 22 and a reference electrode 24. The signal electrode 22 includes a plurality of (in FIG. 1, eight) horizontal electrode portions 22a (in FIG. 1, only one of the horizontal electrode portions 22a is denoted by the reference numeral) and a vertical electrode portion 22b. The vertical electrode portion 22b extends linearly in a longitudinal direction of the substrate 11 (a depth direction of a fuel tank). An upper end of the vertical electrode portion 22b is positioned at an upper end of the substrate 11. The vertical electrode portion 22b is connected to ends on one side (left ends in FIG. 1) of the plurality of horizontal electrode portions 22a. Thus, the plurality of horizontal electrode portions 22a is electrically connected to the vertical electrode portion 22b. The plurality of horizontal electrode portions 22a is disposed such that the horizontal electrode portions 22a are parallel to one another and also disposed perpendicularly to the vertical electrode portion 22b. The plurality of horizontal electrode portions 22a is arranged such that the horizontal electrode portions 22a are disposed at regular intervals in the longitudinal direction of the substrate 11.

On the right of the signal electrode 22, the reference electrode 24 is disposed in association with the signal electrode 22. The reference electrode 24 is grounded. The reference electrode 24 includes a plurality of (in FIG. 1, eight) horizontal electrode portions 24a (in FIG. 1, only one of the horizontal electrode portions 24a is denoted by the reference numeral) and a vertical electrode portion 24b. The vertical electrode portion 24b extends linearly in the longitudinal direction of the substrate 11. An upper end of the vertical electrode portion 24b is positioned at the upper end of the substrate 11. The vertical electrode portion 24b is connected to the plurality of horizontal electrode portions 24a. Thus, the plurality of horizontal electrode portions 24a is electrically connected to the vertical electrode portion 24b. The plurality of horizontal electrode portions 24a is disposed such that the horizontal electrode portions 24a are parallel to one another and also disposed perpendicularly to the vertical electrode portion 24b. The plurality of horizontal electrode portions 24a is arranged such that the horizontal electrode portions 24a are disposed at regular intervals in the longitudinal direction of the substrate 11. The horizontal electrode portions 22a and the horizontal electrode portions 24a are alternately disposed as viewed along a side of the substrate 11 from the upper end to a lower end of the substrate 11.

The pair of electrodes 31 is disposed on the lower surface 30 of the substrate 11. The pair of electrodes 31 includes a signal electrode 32 and a reference electrode 34. The signal electrode 32 includes a plurality of (in FIG. 1, eight) horizontal electrode portions 32a (in FIG. 1, only one of the horizontal electrode portions 32a is denoted by the reference numeral) and a vertical electrode portion 32b. The signal electrode 32 has a same shape as a shape of the signal electrode 22. Furthermore, the signal electrode 32 is at a same position as a position of the signal electrode 22 on the other side of the substrate 11. The reference electrode 34 is disposed in association with the signal electrode 32. The reference electrode 34 is grounded. The reference electrode 34 includes a plurality of (in FIG. 1, eight) horizontal electrode portions 34a (in FIG. 1, only one of the horizontal electrode portions 34a is denoted by the reference numeral) and a vertical electrode portion 34b. The reference electrode 34 has a same shape as a shape of the reference electrode 24. Furthermore, the reference electrode 34 is at a same position as a position of the reference electrode 24 on the other side of the substrate 11. In this configuration, a distance between the signal electrode 32 and the reference electrode 34 is equal to a distance between the signal electrode 22 and the reference electrode 24. More specifically, a distance between the horizontal electrode portions 32a and the horizontal electrode portions 34a which are adjacent to each other is equal to a distance between the horizontal electrode portions 22a and the horizontal electrode portions 24a which ae adjacent to each other. Thus, if the pair of electrodes 21 and the pair of electrodes 31 are disposed in a same environment (for example, in a fuel tank), a capacitance of the pair of electrodes 21 is normally equal to a capacitance of the pair of electrodes 31. An uppermost horizontal electrode portions 22a is positioned above an uppermost horizontal electrode portions 24a. An uppermost horizontal electrode portions 32a is positioned above an uppermost horizontal electrode portions 34a.

The specifying device 50 includes an oscillation circuit 52, two resistors R1 and R2, two switches S1 and S2, a rectifying unit 56, an amplifying unit 58, an arithmetic unit 60, and a temperature detecting unit 62. The oscillation circuit 52 generates a signal (alternating voltage) with a predetermined period (for example, 10 Hz to 3 MHz).

The oscillation circuit 52 is connected to each of the switches S1 and S2 via the resistor R1. The switches S1 and S2 are turned on and off by a control unit (not shown in the drawings). If the switch S1 is on, the signal electrode 22 and the oscillation circuit 52 are connected together. If the switch S1 is off, the signal electrode 22 and the oscillation circuit 52 are not connected together. That is, while the switch S1 is on, the oscillation circuit 52 supplies a signal to the signal electrode 22. If the switch S2 is on, the signal electrode 32 and the oscillation circuit 52 are connected together. If the switch S2 is of, the signal electrode 32 and the oscillation circuit 52 are not connected together. That is, while the switch S2 is on, the oscillation circuit 52 supplies a signal to the signal electrode 32.

The rectifying unit 56 is connected between the resistor R1 and both the signal electrodes 22 and 32. Same signals as the signals supplied to the signal electrodes 22 and 32 is input to the rectifying unit 56. The rectifying unit 56 rectifies the input signal and outputs the rectified signal to the amplifying unit 58. The amplifying unit 58 amplifies the input signal and outputs the amplified signal to the arithmetic unit 60 (MCU).

The control unit controls the switches S1 and S2 to switch the sensor system 2 among a first state to a fourth state. In the first state, the switch S1 is on, and the switch S2 is off. In the first state, the oscillation circuit 52 inputs a signal to the signal electrode 22. As a result, charge is accumulated in the pair of electrodes 21. The capacitance of the pair of electrodes 21 changes correlatively to the concentration of ethanol in the mixed fuel. The resistor R1 has a constant resistance value, and thus, an amplitude of the signal supplied to the signal electrode 22 changes correlatively to the concentration of ethanol. The same signal as the signal supplied to the signal electrode 22 is input to the rectifying unit 56. As a result, a signal correlated to the capacitance of the pair of electrodes 21 is input to the arithmetic unit 60.

In the second state, the switch S1 is off, and the switch S2 is on. In the second state, the oscillation circuit 52 inputs a signal to the signal electrode 32. As a result, charge is accumulated in the pair of electrodes 31. The capacitance of the pair of electrodes 31 changes correlatively to the concentration of ethanol in the mixed fuel. The resistor R1 has a constant resistance value, and thus, an amplitude of the signal supplied to the signal electrode 32 changes correlatively to the concentration of ethanol. The same signal as the signal supplied to the signal electrode 32 is input to the rectifying unit 56. As a result, a signal correlated to the capacitance of the pair of electrodes 31 is input to the arithmetic unit 60.

In the third state, both the switches S1 and S2 are on. In the third state, the pair of electrodes 21 and the pair of electrodes 31 are connected together in parallel. In the third state, the oscillation circuit 52 inputs a signal to the signal electrodes 22 and 32. As a result, charge is accumulated in the pairs of electrodes 21 and 31. With the resistor R1 exhibiting a predetermined resistance, the capacitances of the pairs of electrodes 21 and 31 change correlatively to the concentration of ethanol in the mixed fuel. Thus, amplitudes of the signals supplied to the signal electrodes 22 and 32 change correlatively to the concentration of ethanol. The signals supplied to the signal electrodes 22 and 32 are input to the rectifying unit 56. As a result, a signal correlated to a sum of the capacitance of the pair of electrodes 21 and the capacitance of the pair of electrodes 31 is input to the arithmetic unit 60.

In the fourth state, both the switches S1 and S2 are off. In the fourth state, the rectifying unit 56 is connected in series with the resistor R1. In this case, no signal is supplied to the pairs of electrodes 21 and 31. As a result, a signal that does not change depending on the concentration of ethanol in the mixed fuel is input to the arithmetic unit 60 via the rectifying unit 56.

The control unit consecutively switches from the first state to the fourth state. The control unit also repeats the consecutive switching from the first state to the fourth state. The control unit transmits a current state of the sensor system 2 to the arithmetic unit 60.

The temperature detecting unit 62 is connected via the resistor R2 to a DC power source 54 configured to output, for example, a DC voltage of 5V. The temperature detecting unit 62 includes a resistance temperature detector that has a resistance value changing depending on temperature. The temperature detecting unit 62 uses the resistance temperature detector to detect a temperature of the mixed fuel, and inputs the detected temperature of the mixed fuel to the arithmetic unit 60.

In the third state, the arithmetic unit 60 uses the signal received from the amplifying unit 58 and the temperature of the mixed fuel received from the temperature detecting unit 62 to determine the concentration of ethanol in the mixed fuel. For example, the arithmetic unit 60 uses a database indicative of relations between the capacitances and the temperature of the mixed fuel and the concentration of ethanol which is stored in the arithmetic unit 60, to determine the concentration of ethanol in the mixed fuel. In the third state, the pair of electrodes 21 and the pair of electrodes 31 are connected together in parallel. This configuration can determine the concentration of ethanol using the sum of the capacitances of the two pairs of electrodes 21 and 31. Thus, compared to a configuration that determines the concentration of ethanol using the capacitance of one of the pair of electrodes 21 and the pair of electrodes 31, the above-described configuration can increase a change in the capacitance associated with a change in the concentration of ethanol, that is, the above-described configuration can increase a sensitivity of the sensor 10. Consequently, the arithmetic unit 60 can appropriately detect the concentration of ethanol.

Furthermore, the capacitances of the pairs of electrodes 21 and 31 change depending on the temperature of the mixed fuel. The arithmetic unit 60 uses the temperature of the mixed fuel in detecting the concentration of ethanol. According to this configuration, the arithmetic unit 60 can correct a change in the capacitances of the pair of electrodes 21 and 31 depending on the temperature of the mixed fuel. Thus, the arithmetic unit 60 can more appropriately detect the concentration of ethanol. The concentration of ethanol detected by the arithmetic unit 60 is output to an engine control unit (ECU) 70. The ECU 70 uses the input concentration of ethanol to control an injector and the like. That is, based on the appropriate concentration of ethanol detected by the arithmetic unit 60, the ECU 70 can control the injector and the like. Hence, the mixed fuel can be appropriately supplied to an engine.

In the first state, the signal input to the arithmetic unit 60 (hereinafter referred to as a “first correlation value”) is correlated to the capacitance of the pair of electrodes 21. In the second state, the signal input to the arithmetic unit 60 (hereinafter referred to as a “second correlation value”) is correlated to the capacitance of the pair of electrodes 31. The signal input to the electrodes 21 in the first state is the same as the signal input to the electrodes 31 in the second state. The sensor system 2 is consecutively switched from the first state to the second state. That is, the first correlation value and the second correlation value are consecutively input to the arithmetic unit 60. While the sensor system 2 is operating normally, the consecutively input first and second correlation values are substantially equal.

When the first correlation value and the second correlation value are consecutively input to the arithmetic unit 60, the arithmetic unit 60 compares the input first and second correlation values with each other. If the first correlation value is different from the second correlation value, at least one of the first correlation value and the second correlation value is not correlated to the concentration of ethanol in the mixed fuel. In this case, the correlation between the first correlation value and the second correlation value is disrupted. Then, the arithmetic unit 60 determines that at least one of the pair of electrodes 21 and the pair of electrodes 31 is suffering from a defect such as damage or adhesion of a foreign substance. In this case, the arithmetic unit 60 outputs a signal indicating that a defect is occurring in at least one of the pair of electrodes 21 and the pair of electrodes 31, to the ECU 70. This configuration can determine that a defect is occurring in the sensor 10. As a result, the ECU 70 can be prevented from controlling the units of the sensor based on an incorrect concentration of ethanol.

The arithmetic unit 60 stores a voltage value of the signal input to the arithmetic unit 60 in the fourth state in which the sensor system 2 is operating normally. The arithmetic unit 60 compares the voltage value of the signal input when the sensor system 2 is in the fourth state with a voltage value stored in the arithmetic unit 60. If the voltage value of the input signal is different from the voltage value stored in the arithmetic unit 60, the arithmetic unit 60 determines that a defect (damage to any conducting wire, a failure in any of the units 52, 56, and 58, or the like) is occurring in the sensor system 2. In this case, the arithmetic unit 60 outputs a signal indicating that a defect is occurring in the sensor system 2, to the ECU 70. This configuration can determine that a defect is occurring in the sensor system 2 except for the sensor 10. As a result, the ECU 70 can be prevented from controlling the units of the sensor based on an incorrect concentration of ethanol.

### Second Embodiment

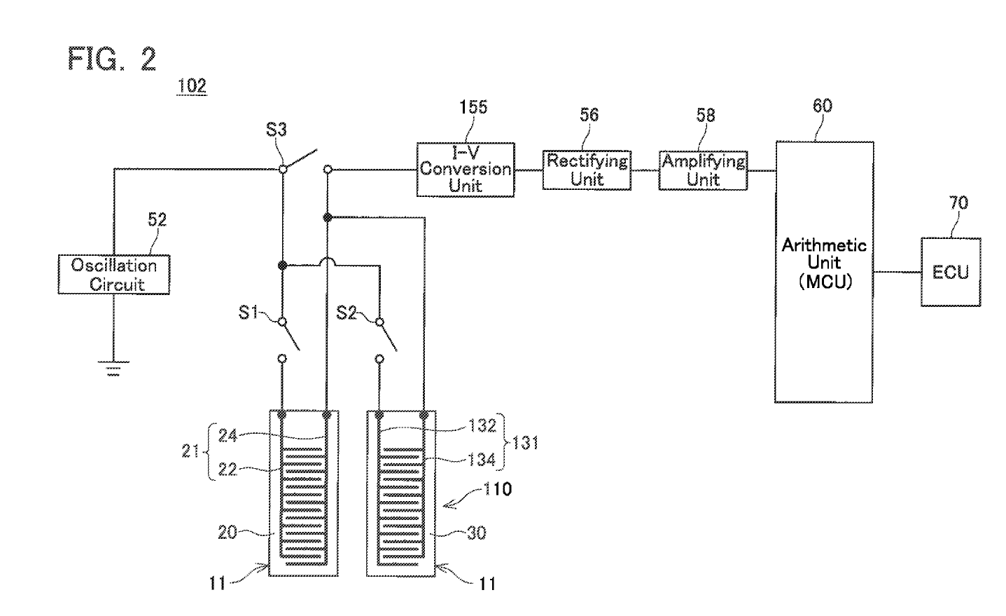

Differences from the first embodiment will mainly be described. A sensor system 102 shown in FIG. 2 includes units 52, 56, 58, 60, S1, and S2 similar to the units 52, 56, 58, 60, S1, and S2 of the sensor system 2 and lacks the resistors R1 and R2, temperature detecting unit 62, and the sensor 10. The sensor system 102 further includes a switch S3, a sensor 110, and a current-voltage conversion unit 155.

The sensor 110 includes a substrate 11 and two pairs of electrodes 21 and 131. Like FIG. 1, FIG. 2 shows an upper surface 20 and a lower surface 30 of the substrate 11 juxtaposed with each other. In actuality, the sensor 110 includes the single substrate 11. A reference electrode 24 of the pair of electrodes 21 is connected to a rectifying unit 56 via the current-voltage conversion unit 155.

The pair of electrodes 131 is disposed on the lower surface 30 of the substrate 11. The pair of electrodes 131 includes a signal electrode 132 and a reference electrode 134. A shape of the signal electrode 132 and a position of the signal electrode 132 on the substrate 11 are the same as the shape of the reference electrode 34 in FIG. 1 and the position of the reference electrode 34 on the substrate 11. A shape of the reference electrode 134 and a position of the reference electrode 134 on the substrate 11 are the same as the shape of the signal electrode 32 in FIG. 1 and the position of the signal electrode 32 on the substrate 11. In this configuration, a distance between the signal electrode 132 and the reference electrode 134 is equal to a distance between a signal electrode 22 and a reference electrode 24. The reference electrode 134 is connected to the rectifying unit 56 via the current-voltage conversion unit 155.

The oscillation circuit 52 is connected to each of the switches S1 to S3. The switches S1 to S3 are turned on and off by a control unit (not shown in the drawings). If the switch S1 is on, the signal electrode 22 and the oscillation circuit 52 are connected together. If the switch S1 is off, the signal electrode 22 and the oscillation circuit 52 are not connected together. That is, while the switch S1 is on, the oscillation circuit 52 supplies a signal to the signal electrode 22. If the switch S2 is on, the signal electrode 132 and the oscillation circuit 52 are connected together. If the switch S2 is off, the signal electrode 132 and the oscillation circuit 52 are not connected together. That is, while the switch S2 is on, the oscillation circuit 52 supplies a signal to the signal electrode 132. If the switch S3 is on, the current-voltage conversion unit 155 and the oscillation circuit 52 are connected directly together (without intervention of the pair of electrodes 21 or 131). If the switch S3 is off, the current-voltage conversion unit 155 and the oscillation circuit 52 are not connected directly together. That is, while the switch S3 is on, the oscillation circuit 52 supplies a signal to the current-voltage conversion unit 155 without passing the signal through the pair of electrodes 21 or 131.

The control unit controls the switches S1 to S3 to switch the sensor system 2 among a first state to a fourth state. In the first state, the switch S1 is on, the switch S2 is off, and the switch 3 is off. In the first state, the pair of electrodes 21 and the current-voltage conversion unit 155 are connected together in series. When the oscillation circuit 52 supplies a signal to the signal electrode 22, charge is accumulated in the pair of electrodes 21. The capacitance of the pair of electrodes 21 changes correlatively to a concentration of ethanol in a mixed fuel. A current value of the current-voltage conversion unit 155 changes correlatively to the capacitance of the pair of electrodes 21, that is, the concentration of ethanol in the mixed fuel. The current-voltage conversion unit 155 converts the current value of the current-voltage conversion unit 155 into a signal (voltage value) and outputs the signal to the rectifying unit 56. Thus, the voltage value of the signal input to the rectifying unit 56 is changed by the capacitance of the pair of electrodes 21. As a result, a signal correlated to the capacitance of the pair of electrodes 21 is input to the arithmetic unit 60.

In the second state, the switch S1 is off, the switch S2 is on, and the switch S3 is off. In the second state, the pair of electrodes 131 and the current-voltage conversion unit 155 are connected together in series. When the oscillation circuit 52 supplies a signal to the signal electrode 132, charge is accumulated in the pair of electrodes 131. A capacitance of the pair of electrodes 131 changes correlatively to the concentration of ethanol in the mixed fuel. The current value of the current-voltage conversion unit 155 changes correlatively to the capacitance of the pair of electrodes 131, that is, the concentration of ethanol in the mixed fuel. The current-voltage conversion unit 155 converts the current value of the current-voltage conversion unit 155 into a signal (voltage value) and outputs the signal to the rectifying unit 56. Thus, the voltage value of the signal input to the rectifying unit 56 is changed by the capacitance of the pair of electrodes 131. As a result, a signal correlated to the capacitance of the pair of electrodes 131 is input to the arithmetic unit 60.

In the third state, both the switch S1 and the switch S2 are on, and the switch S3 is off. In the third state, the pair of electrodes 21 and the pair of electrodes 131 are connected together in parallel and connected in series with the current-voltage conversion unit 155. When the oscillation circuit 52 supplies a signal to the signal electrodes 22 and 132, charge is accumulated in the pairs of electrodes 21 and 131. A sum of the capacitances of the pairs of electrodes 21 and 131 changes correlatively to the concentration of ethanol in the mixed fuel. The current value of the current-voltage conversion unit 155 changes correlatively to the capacitances of the pairs of electrodes 21 and 131, that is, the concentration of ethanol in the mixed fuel. Thus, the current-voltage conversion unit 155 converts the current value of the current-voltage conversion unit 155 into a signal (voltage value) and outputs the signal to the rectifying unit 56. The voltage value of the signal input to the rectifying unit 56 is correlated to the sum of the capacitances of the pairs of electrodes 21 and 131, that is, the concentration of ethanol. As a result, a signal correlated to the concentration of ethanol is input to the arithmetic unit 60.

In the third state, the arithmetic unit 60 uses the signal received from the amplifying unit 58 to determine the concentration of ethanol in the mixed fuel. Like the sensor system 2, this configuration can increase a change in the capacitance associated with a change in the concentration of ethanol (that is, the configuration can increase a sensitivity of the sensor 110). Consequently, the arithmetic unit 60 can appropriately detect the concentration of ethanol.

In the fourth state, both the switches S1 and S2 are off, and the switch S3 is on. In the fourth state, the current-voltage conversion unit 155 is connected directly to the oscillation circuit 52 (without intervention of the pair of electrodes 21 or 131), with no signal input to the pairs of electrodes 21 and 131. As a result, a signal that does not change depending on the concentration of ethanol in the mixed fuel is input to the arithmetic unit 60 via the current-voltage conversion unit 155 and the rectifying unit 56.

The control unit consecutively switches from the first state through the fourth state. The control unit also repeats the consecutive switching from the first state through the fourth state. The control unit transmits a current state of the sensor system 2 to the arithmetic unit 60.

In the first state, the signal input to the arithmetic unit 60 (hereinafter referred to as a “first correlation value”) is correlated to the capacitance of the pair of electrodes 21. In the second state, the signal input to the arithmetic unit 60 (hereinafter referred to as a “second correlation value”) is correlated to the capacitance of the pair of electrodes 131. The signal input to the electrodes 21 in the first state is the same as the signal input to the electrodes 131 in the second state. The sensor system 102 is consecutively switched from the first state to the second state. That is, the first correlation value and the second correlation value are consecutively input to the arithmetic unit 60. While the sensor system 102 is operating normally, the consecutively input first and second correlation values are substantially equal.

When the first correlation value and the second correlation value are consecutively input to the arithmetic unit 60, the arithmetic unit 60 compares the input first and second correlation values with each other. If the first correlation value is different from the second correlation value, at least one of the first correlation value and the second correlation value is not correlated to the concentration of ethanol in the mixed fuel. In this case, the arithmetic unit 60 determines that at least one of the pair of electrodes 21 and the pair of electrodes 131 is suffering from a defect such as damage or adhesion of a foreign substance. Like the sensor system 2, this configuration can prevent the ECU 70 from controlling the units of the sensor based on an incorrect concentration of ethanol.

Furthermore, the arithmetic unit 60 compares the voltage value of the signal input when the sensor system 102 is in the fourth state with a voltage value stored in the arithmetic unit 60. If the voltage value of the input signal is different from the voltage value stored in the arithmetic unit 60, the arithmetic unit 60 determines that a defect (damage to any conducting wire, a failure in any of the units 52, 56, and 58, or the like) is occurring in the sensor system 102. In this case, the arithmetic unit 60 outputs a signal indicating that a defect is occurring in the sensor system 102, to the ECU 70. This configuration can determine that a defect is occurring in the sensor system 102 except for the sensor 110. As a result, the ECU 70 can be prevented from controlling the units of the sensor based on an incorrect concentration of ethanol.

### Third embodiment

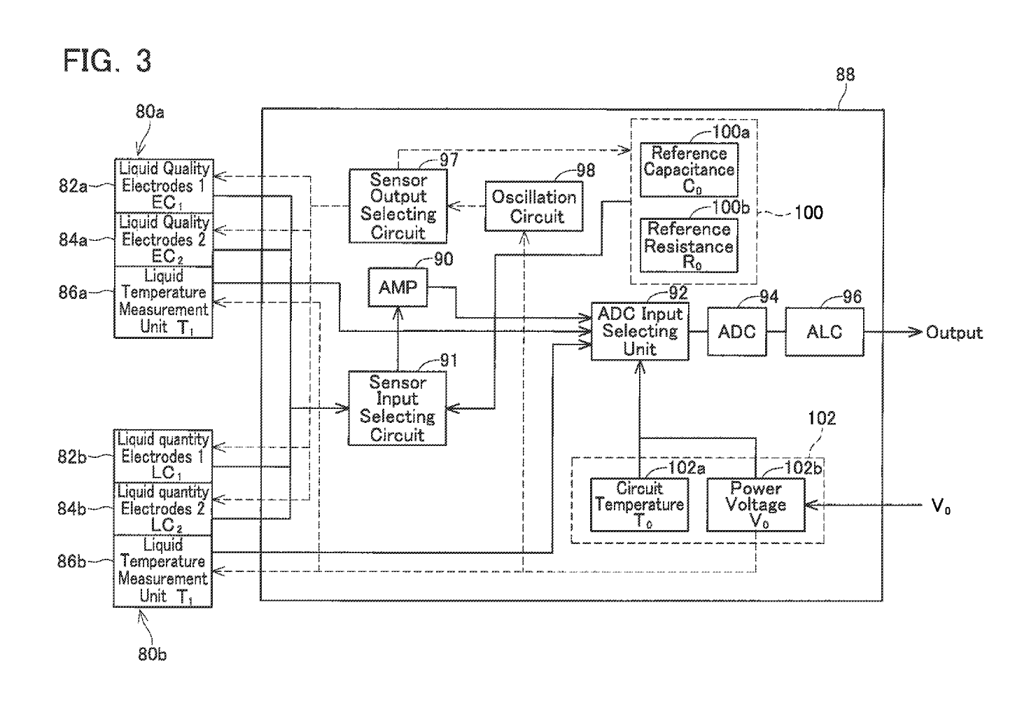

A sensor system according to a third embodiment will be described with reference to FIG. 3. As shown in FIG. 3, the sensor system according to the third embodiment includes a liquid quality sensor 80a, a liquid level sensor 80b, and a specifying device 88 connected to the sensors 80a and 80b.

The liquid quality sensor 80a has substantially the same configuration as the configuration of the sensor 11 according to the first embodiment except that the liquid quality sensor 80a further includes a liquid temperature measurement unit 86a configured to measure the temperature of the mixed fuel. That is, the liquid quality sensor 80a includes a first pair of electrodes 82a configured to measure quality of the mixed fuel (that is, an ethanol concentration of the mixed fuel), a second pair of electrodes 84a configured to measure the quality of the mixed fuel (that is, the ethanol concentration of the mixed fuel), and the liquid temperature measurement unit 86a configured to measure the temperature of the mixed fuel. The first pair of electrodes 82a and the second pair of electrodes 84a have a same configuration as the configuration of the pairs of electrodes 21 and 31 of the sensor 11 according to the first embodiment. The liquid temperature measurement unit 86a is a resistance heat-sensitive element such as a thermistor.

The liquid quality sensor 80a is disposed on an upper surface of a fuel tank configured to store the mixed fuel. The liquid quality sensor 80a is contained in a case to which surplus fuel from a pressure regulator is supplied. That is, the fuel tank includes a fuel pump disposed therein and configured to supply the mixed fuel in the fuel tank to an engine, and the pressure regulator disposed in the fuel tank and configured to adjust a pressure of the mixed fuel discharged from the fuel pump. The pressure regulator is connected via piping to the case containing the liquid quality sensor 80a so that surplus fuel from the pressure regulator is fed into the case through the piping. The surplus fuel fed into the case is returned to the fuel tank through a discharge port formed in the case. Consequently, the liquid quality sensor 80a comes into contact with the surplus fuel fed into the case to measure quality and a temperature of the surplus fuel. When the fuel pump stops operation, the feeding of the surplus fuel into the case containing the liquid quality sensor 80a is stopped. Thus, the mixed fuel in the case is discharged to outside of the case through the discharge port. As a result, the liquid quality sensor 80a is exposed to atmosphere.

The liquid level sensor 80b has a configuration similar to the configuration of the liquid quality sensor 80a to measure the level and temperature of the mixed fuel in the fuel tank. That is, the liquid level sensor 80b includes a first pair of electrodes 82b configured to measure the level of the mixed fuel, a second pair of electrodes 84b configured to measure the level of the mixed fuel, and a liquid temperature measurement unit 86b configured to measure the temperature of the mixed fuel. The liquid level sensor 80b is disposed in the fuel tank to measure the level of the mixed fuel in the fuel tank. Furthermore, the first pair of electrodes 82b and the second pair of electrodes 84b are disposed so as to extend from a position close to a lower surface of the fuel tank to a position close to an upper surface of the fuel tank.

The specifying device 88 is connected to the liquid quality sensor 80a and the liquid level sensor 80b. Signals output by the sensors 80a and 80b are input to the specifying device 88. The specifying device 88 is also connected to an external power source (not shown in the drawings) and an engine ECU. Power from the external power source is supplied to the specifying device 88. The power supplied to the specifying device 88 is fed to the liquid temperature measurement unit 86a of the liquid quality sensor 80a and to the liquid temperature measurement unit 86b of the liquid level sensor 80b. The specifying device 88 includes an oscillation circuit 98, a sensor output selecting circuit 97, a sensor input selecting circuit 91, a signal amplifying unit 90, an input selecting unit 92, an AD converter 94, an arithmetic unit 96, a reference equivalent circuit 100, and a temperature compensating circuit 102.

The oscillation circuit 98 generates a signal (AC voltage) using power supplied by the external power source. The sensor output selecting circuit 97 selects a target to which the signal generated by the oscillation circuit 98 is output. That is, the sensor output selecting circuit 97 outputs the signal (AC voltage) from the oscillation circuit 98 to either the pairs of electrodes 82a and 84a of the liquid quality sensor 80a or the pairs of electrodes 82b and 84b of the liquid level sensor 80b or the reference equivalent circuit 100. The target to which the signal is output is selected by the sensor output selecting circuit 97 based on an instruction from the arithmetic unit 96. The sensor input selecting circuit 91 selects either signals output from the pairs of electrodes 82a and 84a of the liquid quality sensor 80a or signals output from the pairs of electrodes 82b and 84b of the liquid level sensor 80b or a signal output from the reference equivalent circuit 100. The sensor input selecting circuit 91 then inputs the selected signals to the signal amplifying unit 90. The signal amplifying unit 90 amplifies the signals selected by the sensor input selecting circuit 91. The input selecting unit 92 selects either a signal received from the signal amplifying unit 90, a signal received from the liquid temperature measurement unit 86a of the liquid quality sensor 80a or a signal received from the liquid temperature measurement unit 86b of the liquid level sensor 80b. The input selecting unit 92 then outputs the selected signal to the AD converter 94. The AD converter 94 converts the signal (analog signal) output from the input selecting unit 92 into a digital signal. The arithmetic unit 96 processes the signal received from the AD converter 94 to determine the quality and level of the mixed fuel, and outputs the determined quality and level to the engine ECU. Furthermore, as described below, the arithmetic unit 96 uses outputs from the reference equivalent circuit 100 and the temperature compensating circuit 102 to carry out a process of correcting (calibrating) the signal output from the liquid quality sensor 80a and the signal output from the liquid level sensor 80b.

First, the reference equivalent circuit 100 and the temperature compensating circuit 102 will be described. The reference equivalent circuit 100 includes a reference capacitance 100a and a reference resistance 100b. The reference capacitance 100a and the reference resistance 100b form a reference equivalent circuit (RC circuit) corresponding to a circuit (that is, an RC circuit) including the pairs of electrodes 82a and 84a of the liquid quality sensor 80a and the pairs of electrodes 82b and 84b of the liquid level sensor 80b. The signal from the oscillation circuit 98 is input to the reference equivalent circuit 100. A signal output from the reference equivalent circuit 100 is input to the arithmetic unit 96 via the input selecting unit 92 and the AD converter 94.

The temperature compensating circuit 102 includes a circuit temperature measurement unit 102a and a power voltage measurement section 102b. The circuit temperature measurement unit 102a is a resistance element such as a thermistor which measures a temperature of the specifying device 88. The power voltage measurement section 102b measures a voltage of power supplied to the liquid temperature measurement unit 86a of the liquid quality sensor 80a and the liquid temperature measurement unit 86b of the liquid level sensor 80b. A signal (the temperature of the specifying device 88) output from the circuit temperature measurement unit 102a and a signal output from the power voltage measurement section 102b are input to the arithmetic unit 96 via the input selecting unit 92 and the AD converter 94.

Now, a sensor output correcting process carried out by the arithmetic unit 96 will be described. The arithmetic unit 96 corrects a signal output from the liquid quality sensor 80a and a signal output from the liquid level sensor 80b based on the signal (that is, the temperature of the specifying device 88) output from the circuit temperature measurement unit 102a and the signal (that is, the power voltage) output from the power voltage measurement section 102b. That is, a change in the temperature of the specifying device 88 changes a frequency of the signal output from the oscillation circuit 98. A change in frequencies of the signals input to the liquid quality sensor 80a and the liquid level sensor 80b changes the signals output from the pairs of electrodes 82a and 84a of the liquid quality sensor 80a and the pairs of electrodes 82b and 84b of the liquid level sensor 80b. Thus, the arithmetic unit 96 corrects the signals output from the pairs of electrodes 82a and 84a as well as 82b and 84b based on the temperature of the specifying device 88. For example, the arithmetic unit 96 prestores a correction factor associated with the temperature of the specifying device and multiplied by the signals output from the pairs of electrodes 82a and 84a as well as 82b and 84b.

Furthermore, a change in the power voltage supplied to the liquid temperature measurement units 86a and 86b of the liquid quality sensor 80a and the liquid level sensor 80b changes voltages of the signals of the liquid temperature measurement units 86a and 86b. That is, the liquid temperature measurement unit 86a and 86b are resistors, and thus, a change in the voltage of the input power changes the voltage of the output signal. Hence, the arithmetic unit 96 corrects the voltages of the signals of the liquid temperature measurement units 86a and 86b based on the power voltage. For example, the arithmetic unit 96 multiplies the signals output from the liquid temperature measurement units 86a and 86b by the correction factor associated with the power voltage. The arithmetic unit 96 determines that at least one of the liquid temperature measurement units 86a and 86b is at fault if the signal output from the liquid temperature measurement unit 86a is significantly different from the signal output from the liquid temperature measurement unit 86b. A signal indicating that the liquid temperature measurement unit 86a or 86b is at fault is output from the arithmetic unit 96 to the outside (engine ECU or the like).

Moreover, the arithmetic unit 96 corrects the signals output from the pair of electrodes 82a and 84a of the liquid quality sensor 80a and the pair of electrodes 82b and 84b of the liquid level sensor 80b based on the signal output from the reference equivalent circuit 100. That is, a secular change or the like in the specifying device 88 may change the signal output from the oscillation circuit 98. A change in the signal output from the oscillation circuit 98 changes the signal output from the reference equivalent circuit 100 and the signals output from the pairs of electrodes 82a and 84a as well as 82b and 84b. Here, the reference capacitance 100a and reference resistance 100b of the reference equivalent circuit 100 are known, allowing a frequency or the like of the signal input to the reference equivalent circuit 100 to be determined. Thus, the arithmetic unit 96 determines the frequency or the like of the signal input to the reference equivalent circuit 100 to correct the signals output from the pairs of electrodes 82a and 84a as well as 82b and 84b based on the determined frequency or the like. The arithmetic unit 96 determines that the pair of electrodes 82a, 84a, 82b or 84b is at fault if the signal output from the pair of electrodes 82a is significantly different from the signal output from the pair of electrodes 84a or if the signal output from the pair of electrodes 82b is significantly different from the signal output from the pair of electrodes 84b. A signal indicating that the pair of electrodes 82a and 84a or 82b and 84b is at fault is output to the outside (engine ECU or the like) by the arithmetic unit 96.

Moreover, while the fuel pump is at rest, the arithmetic unit 96 corrects the signal output from the pair of electrodes 82a and 84a of the liquid quality sensor 80a based on the signal output from the pair of electrodes 82a and 84a of the liquid quality sensor 80a. That is, while the fuel pump is at rest, the mixed fuel is discharged from inside the case containing the liquid quality sensor 80a, with the pair of electrodes 82a and 84a of the liquid quality sensor 80a exposed to the atmosphere. A dielectric constant of the atmosphere (air) is known, and thus, a capacitance of the pair of electrodes 82a and 84a can be estimated. On the other hand, an individual difference among liquid quality sensors 80a or a secular change in the liquid quality sensor 80a may cause a capacitance of the liquid quality sensor 80a to deviate from a design value. In such a case, the estimated capacitance of the pair of electrodes 82a and 84a is different from the capacitance of the pair of electrodes 82a and 84a actually measured while the fuel pump is at rest. Thus, the arithmetic unit 96 determines a correction factor for correcting the signal output from the pair of electrodes 82a and 84a of the liquid quality sensor 80a based on the signal output from the pair of electrodes 82a and 84a of the liquid quality sensor 80a while the fuel pump is at rest. This eliminates a variation in measured value caused by the individual difference among liquid quality sensors 80a or the secular change in the liquid quality sensor 80a.

Moreover, the arithmetic unit 96 corrects the signal output from the pair of electrodes 82b and 84b of the liquid level sensor 80b based on the signal output from the pair of electrodes 82b and 84b of the liquid level sensor 80b while the fuel tank is full of fuel. That is, while the fuel tank is full of fuel, all of the pair of electrodes 82b and 84b of the liquid level sensor 80b is immersed in the fuel. On the other hand, a dielectric constant of the fuel can be determined based on the output from the liquid quality sensor 80a, allowing a capacitance of the pair of electrodes 82b and 84b to be estimated. On the other hand, an individual difference among liquid level sensors 80b or a secular change in the liquid level sensor 80b may cause a capacitance of the liquid level sensor 80b to deviate from a design value. In such a case, the estimated capacitance of the pair of electrodes 82b and 84b is different from the capacitance of the pair of electrodes 82b and 84b actually measured while the fuel tank is full of fuel. Thus, the arithmetic unit 96 determines a correction factor for correcting the signal output from the pair of electrodes 82b and 84b of the liquid level sensor 80b based on the signal output from the pair of electrodes 82b and 84b of the liquid level sensor 80b while the fuel tank is full of fuel. This eliminates a variation in measured value caused by the individual difference among liquid level sensors 80b or the secular change in the liquid level sensor 80b.

As described above, the sensor system according to the third embodiment corrects the signals output from the sensors 80a and 80b, and can thus accurately measure the quality and level of the fuel in the fuel tank. The sensor system according to the first embodiment can also self-diagnose a possible failure in the sensors 80a and 80b and a possible failure in the specifying device 88.

### Variation

(1) According to the above-described embodiments, if the signal from the oscillation circuit 52 is supplied to the two pairs of electrodes 21 and 31 or the like provided on the upper and lower surfaces, respectively, of the substrate 11, charge with the same capacitance is accumulated in the pairs of electrodes 21 and 31. According to the first embodiment, each of the electrodes 22 and 24 of the pair of electrodes 21 has the same shape as the shape of each of the electrodes 32 and 34 of the pair of electrodes 31. The distance between the two electrodes 22 and 24 is equal to the distance between the two electrodes 32 and 34. However, the capacitance of the pair of electrodes on the upper surface of the substrate need not be the same as the capacitance of the pair of electrodes on the lower surface of the substrate. In this case, the two pairs of electrodes may be provided such that the capacitance of the pair of electrodes on the upper surface of the substrate is correlated (positively correlated) to the capacitance of the pair of electrodes on the lower surface of the substrate. For example, the two pairs of electrodes may be provided such that the capacitance of the pair of electrodes on the upper surface of the substrate is double the capacitance of the pair of electrodes on the lower surface of the substrate. According to this configuration, if the first correlation value (a value correlated to the capacitance of the pair of electrodes on the upper surface of the substrate) is not substantially double the second correlation value (a value correlated to the capacitance of the pair of electrodes on the lower surface of the substrate), the arithmetic unit 60 may determine that at least one of the two pairs of electrodes is suffering from a defect such as damage or adhesion of a foreign substance.

(2) According to the above-described embodiments, the capacitances of the pair of electrodes 21 or the like change correlatively to the concentration of ethanol in the mixed fuel. However, the pair of electrodes 21 or the like may be provided such that the capacitance of the pair of electrode 21 or the like changes correlatively to the level of the fuel.

(3) According to the above-described embodiments, the arithmetic unit 60 compares the first correlation value with the second correlation value to determine that at least one of the two pairs of electrodes 21 and 31 or the like is suffering from a defect. The arithmetic unit 60 then outputs, to the ECU 70, the signal indicating that at least one of the two pairs of electrodes 21 and 31 or the like is suffering from a defect. However, the arithmetic unit 60 may compare the first correlation value with the second correlation value to output a comparison result. For example, the arithmetic unit 60 may output “0” if the two correlation values are equal and output “1” if the two correlation values are different. In this case, the ECU 70 may determine whether or not at least one of the two pairs of electrodes 21 and 31 or the like is suffering from a defect, depending on the value received from the arithmetic unit 60. Alternatively, the ECU 70 may light a lamp indicating a defect only if the ECU 70 receives the value “1” from the arithmetic unit 60.

### Fourth Embodiment

(Configuration of the Sensor System 1200)

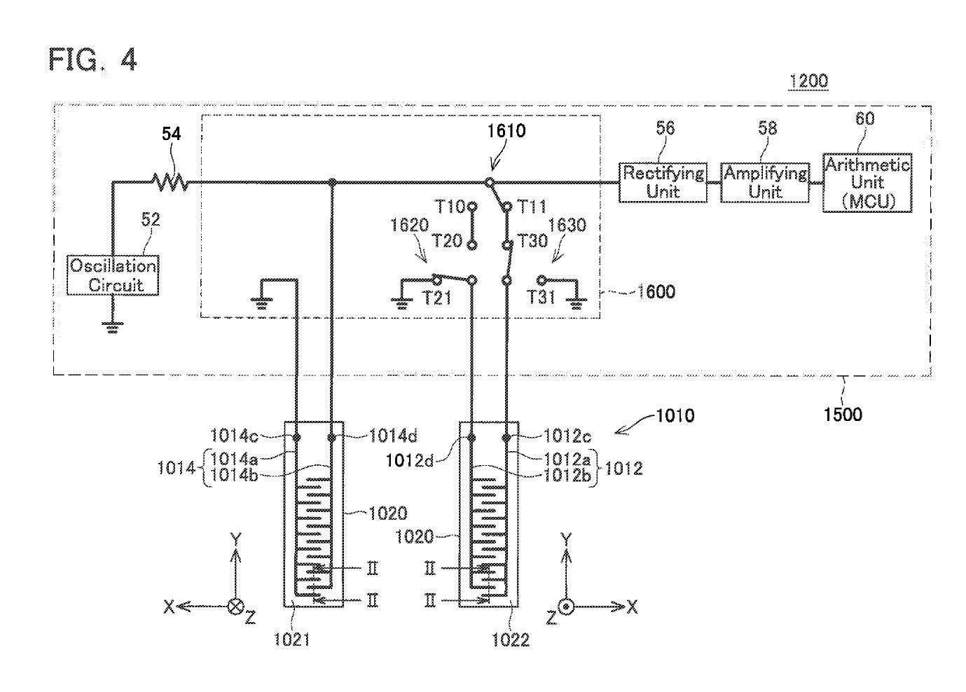

As shown in FIG. 4, a sensor system 1200 includes a sensor 1010 and a specifying device 1500. The sensor 1010 is disposed inside a fuel tank (not shown in the drawings), and the specifying device 1500 is disposed outside the fuel tank. The sensor system 1200 is used to determine the ethanol concentration of a mixed fuel containing the ethanol.

(Configuration of the Specifying Device 1500)

The specifying device 1500 includes an oscillation circuit 52, a resistance unit 54, a rectifying unit 56, a signal amplifying unit 58, an arithmetic unit (MCU) 60, and a connection unit 1600.

The oscillation circuit 52 generates a signal (voltage) with a specific frequency. The oscillation circuit 52 is connected to the connection unit 1600 via the resistance unit 54. The connection unit 1600 is connected to the sensor unit 1010 and the rectifying unit 56. The sensor unit 1010 is connected to the connection unit 1600 at connecting units 1014c, 1014d, 1012c, and 1012d. A specific configuration of the sensor unit 1010 will be described below.

The connection unit 1600 includes switches 1610, 1620, and 1630 as a switching device configured to switch a connection state. The switch 1610 switches between a state in which the oscillation circuit 52 and the rectifying unit 56 are connected to a terminal T10 and a state in which the oscillation circuit 52 and the rectifying unit 56 are connected to a terminal T11. The switch 1620 switches between a state in which the connecting unit 1012d is connected to a terminal T20 and a state in which the connecting unit 1012d is connected to a terminal T21. The switch 1630 switches between a state in which the connecting unit 1012c is connected to a terminal T30 and a state in which the connecting unit 1012c is connected to a terminal T31.

The rectifying unit 56 is connected to the switch 1610. A signal (voltage) at the switch 1610 is input to the rectifying unit 56. The rectifying unit 56 rectifies the input signal (voltage). The signal rectified by the rectifying unit 56 is input to the amplifying unit 58. The amplifying unit 58 amplifies the input signal (voltage). The signal (voltage) at the switch 1610 is input to the arithmetic unit 60 via the rectifying unit 56 and the amplifying unit 58. The resistance unit 54 has a constant resistance value, and thus, an output value of a voltage signal output to the arithmetic unit 60 changes depending on a capacitance C of the sensor unit 1010. The arithmetic unit 60 can calculate the capacitance C of the sensor unit 1010 from the output value of the voltage signal output to the arithmetic unit 60. The capacitance C of the sensor unit 1010 changes depending on the concentration of ethanol contained in the mixed fuel in which the sensor unit 1010 is immersed. The arithmetic unit 60 stores databases that allow the concentration of ethanol to be calculated using the capacitance C obtained. The databases are pre-created based on tests or the like and stored in the arithmetic unit 60.

(Configuration of the Sensor Unit 1010)

The sensor unit 1010 includes a first pair of electrodes 1014 formed on an upper surface 1021 of a substrate 1020 and a second pair of electrodes 1012 formed on a lower surface 1022 of the substrate 1020. The substrate 1020 is formed using a dielectric as a material and formed of polyimide according to the present embodiment. However, the substrate 1020 may be formed of another dielectric material such as poly phenylene sulfide resin (PPS). The substrate 1020 is a rectangular plate. The upper surface 1021 and the lower surface 1022 are opposite surfaces of the substrate 1020. The first pair of electrodes 1014 has a comb-like first electrode 1014a and a comb-like second electrode 1014b disposed on the upper surface 1021 apart from each other. The second pair of electrodes 1012 has a comb-like third electrode 1012a and a comb-like fourth electrode 1012b disposed on the lower surface 1022 apart from each other. The first electrode 1014a, the second electrode 1014b, the third electrode 1012a, and the fourth electrode 1012b are connected to the connection unit 1600 at the connecting units 1014c, 1014d, 1012c, and 1012d, respectively. The connecting unit 1014c is grounded. The connecting unit 1014d is connected between the resistance unit 54 and the switch 1610. The connecting unit 1012c is connected to the switch 1630. The connecting unit 1012d is connected to the switch 1620.

As shown in FIG. 4, the first electrode 1014a includes a handle unit extending, in a negative direction of a Y axis, from the connecting unit 1014c along an end of the upper surface 1021 located in a positive direction of an X axis, and a comb tooth unit extending from the handle unit in a negative direction of the X axis. The second electrode 1014b includes a handle unit extending, in the negative direction of the Y axis, from the connecting unit 1014d along an end of the upper surface 1021 located in the negative direction of the X axis, and a comb tooth unit extending from the handle unit in the positive direction of the X axis. The comb tooth unit of the first electrode 1014a and the comb tooth unit of the second electrode 1014b are spaced at intervals in the Y direction and are partly opposite to each other. The third electrode 1012a includes a handle unit extending, in the negative direction of the Y axis, from the connecting unit 1012c along an end of the lower surface 1022 located in the positive direction of the X axis, and a comb tooth unit extending from the handle unit in the negative direction of the X axis. The fourth electrode 1012b includes a handle unit extending, in the negative direction of the Y axis, from the connecting unit 1012d along an end of the lower surface 1022 located in the negative direction of the X axis, and a comb tooth unit extending from the handle unit in the positive direction of the X axis. The comb tooth unit of the third electrode 1012a and the comb tooth unit of the fourth electrode 1012b are spaced at intervals in the Y direction and are partly opposite to each other.

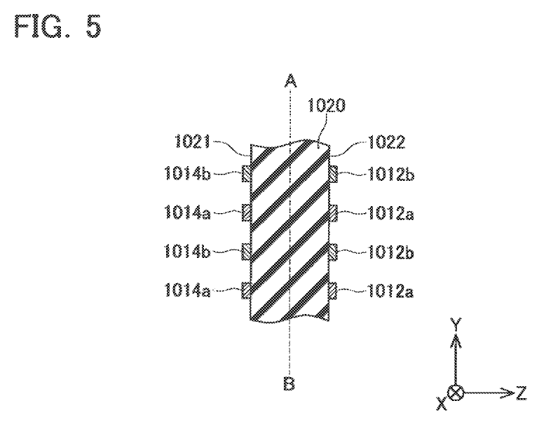

As shown in FIG. 4 and FIG. 5, the first electrode 1014a and the third electrode 1012a are disposed so as to pass through a center of the substrate 1020 in a direction of a Z axis and positioned symmetrically with respect to a surface perpendicular to the Z axis (the surface shown by a segment A-B in FIG. 5). That is, the third electrode 1012a is formed at a position opposite to the first electrode 1014a via the substrate 1020. Furthermore, the second electrode 1014b and the fourth electrode 1012b are disposed so as to pass through the center of the substrate 1020 in the direction of the Z axis and positioned symmetrically with respect to the surface perpendicular to the Z axis. That is, the fourth electrode 1012b is formed at a position opposite to the second electrode 1014b via the substrate 1020.

(Method for Measuring the Capacitance)

The specifying device 1500 has a control unit (not shown in the drawings) configured to supply power to the sensor unit 1010 and to measure a capacitance C of the sensor unit 1010. Specifically, the control unit of the specifying device 1500 switches the switch 1610 and the like of the connection unit 1600 to manipulate connections among the first electrode 1014a, second electrode 1014b, third electrode 1012a, and fourth electrode 1012b of the sensor unit 1010 to measure the capacitance C of the sensor unit 1010.

First, as shown in FIG. 1, the specifying device 1500 connects the switch 1610 to the terminal T11, the switch 1620 to the terminal T21, and the switch 1630 to the terminal T30 to obtain a first output. The arithmetic unit 60 then uses the first output to calculate the capacitance C of the sensor unit 1010. In this case, the first electrode 1014a and the fourth electrode 1012b are grounded to provide a first potential V1 (0 V). Furthermore, the oscillation circuit 52 applies a voltage to the second electrode 1014b and the third electrode 1012a, which provide a second potential V2 (V2≠V1=0). The first pair of electrodes 1014 and the second pair of electrodes 1012 are connected together in parallel. As a result, a potential difference with a magnitude V1 occurs between the opposite electrodes on the upper surface 1021 or lower surface 1022 of the substrate 1020 (between the first electrode 1014a and the second electrode 1014b and between the third electrode 1012a and the fourth electrode 1012b). Moreover, a potential difference with the magnitude V1 also occurs between the electrodes opposite to each other with the substrate 1020 in between (between the first electrode 1014a and the third electrode 1012a and between the second electrode 1014b and the fourth electrode 1012b). A capacitive component between the opposite electrodes on the upper surface 1021 or lower surface 1022 of the substrate 1020 (a capacitance of this capacitive component is denoted by Cy) is connected in parallel with a capacitive component between the electrodes opposite to each other with the substrate 1020 in between (a capacitance of this capacitive component is denoted by Cz). Thus, the capacitance C of the sensor unit 1010 is obtained by C(1)−Cy+Cz. A voltage signal corresponding to the capacitance C is output to the arithmetic unit 60 as the first output.

Then, on the connection unit 1600, the specifying device 1500 connects the switch 1610 to the terminal T10, the switch 1620 to the terminal T20, and the switch 1630 to the terminal T31 to obtain a second output. The arithmetic unit 60 then uses the second output to calculate the capacitance C of the sensor unit 1010. In this case, the first electrode 1014a and the third electrode 1012a are grounded to provide the first potential. The oscillation circuit 52 applies a voltage to the second electrode 1014b and the fourth electrode 1012b, which provide the second potential V2. The first pair of electrodes 1014 and the second pair of electrodes 1012 are connected together in parallel. Thus, a potential difference with the magnitude V1 occurs between the opposite electrodes on the upper surface 1021 or lower surface 1022 of the substrate 1020. On the other hand, the electrodes opposite to each other with the substrate 1020 in between are at the same potential. As a result, the capacitance Cz of the capacitive component between the electrodes opposite to each other with the substrate 1020 in between is such that Cz≅0. Only the capacitance Cy of the capacitive component between the opposite electrodes on the upper surface 1021 or lower surface 1022 of the substrate 1020 is detected as the capacitance C(2) of the sensor unit 1010 (C(2)=Cy). A voltage signal corresponding to the capacitance C is output to the arithmetic unit 60 as the second output.

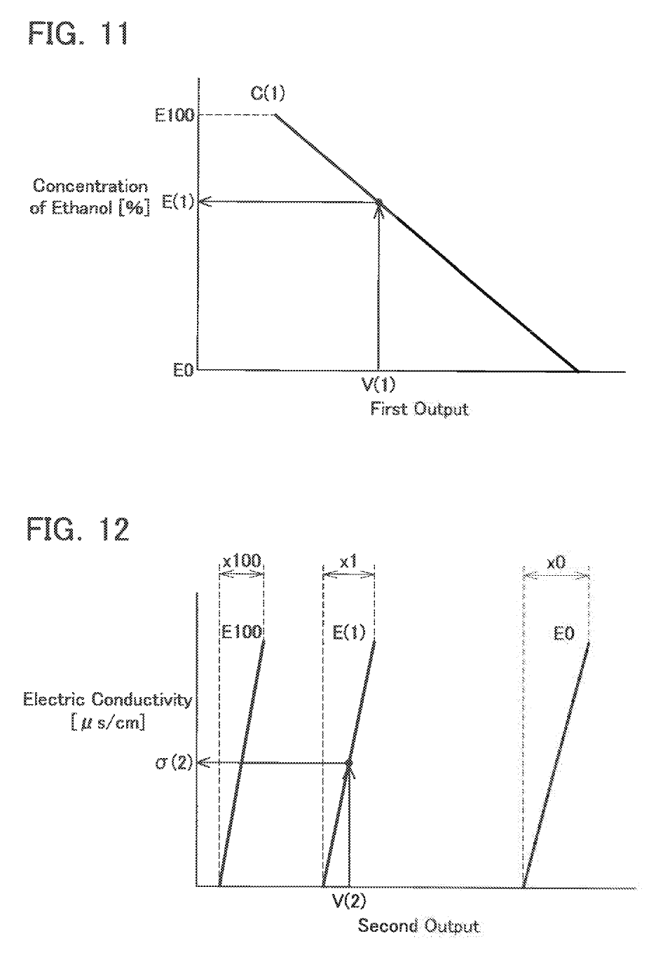

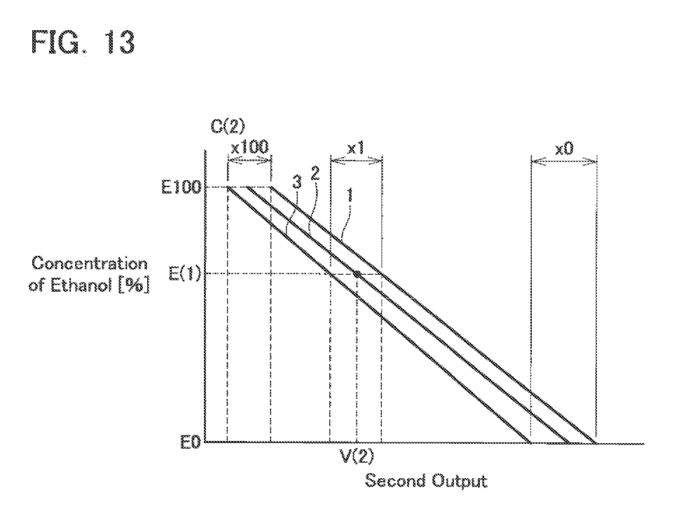

The specifying device 1500 calculates the concentration of ethanol contained in the mixed fuel and an electric conductivity of the mixed fuel based on the capacitance C(1) obtained from the first output and the capacitance C(2) obtained from the second output. An example of a method for calculating the electric conductivity will be described with reference to FIG. 11 to FIG. 13. FIG. 11 is a diagram showing a relation between the first output provided to the arithmetic unit 60 in association with the capacitance C(1) and the concentration of ethanol contained in the mixed fuel. An impact of the electric conductivity of the measured liquid on the first output is sufficiently small, and thus, an ethanol concentration E(1) of the mixed fuel can be determined based on the relation shown in FIG. 11. FIG. 12 is a diagram showing a relation at respective ethanol concentrations between the second output provided to the arithmetic unit in association with the capacitance C(2) and the electric conductivity of the mixed fuel. As shown in FIG. 12, the second output changes under an effect of the electric conductivity of the mixed fuel. At the same ethanol concentration, the second output increases and decreases consistently with the electric conductivity. If the ethanol concentration is E(1), the second output changes by x1 within a range of the electric conductivity shown in FIG. 12. Similarly, at ethanol concentrations E100 and E0, the second output changes by x100 and by x0, respectively. FIG. 13 is a diagram showing a relation between the second output provided to the arithmetic unit 60 in association with the capacitance C(2) and the concentration of ethanol contained in the mixed fuel. A straight line shown at reference numeral 1 shows a relation between the second output and the ethanol concentration obtained if the electric conductivity is maximum within the range of electric conductivity shown in FIG. 12. A straight line shown at reference numeral 2 shows a relation between the second output and the ethanol concentration obtained if the electric conductivity is σ(2). A straight line shown at reference numeral 3 shows a relation between the second output and the ethanol concentration obtained if the electric conductivity is minimum within the range of electric conductivity shown in FIG. 12. When the first output and the second output are measured for the mixed fuel, then first, the ethanol concentration E(1) of the mixed fuel can be determined based on the relation shown in FIG. 11. Then, based on the relation, shown in FIG. 12, between the electric conductivity and the second output at the ethanol concentration E(1) obtained, the electric conductivity σ(2) can be determined. Relations between the second output and the electric conductivity at ethanol concentrations which are not shown in FIG. 12 can be determined by compensation using relations between the second output and the electric conductivity at a plurality of ethanol concentrations (for example, ethanol concentrations E1 and E100). The relations between the output and the electric conductivity at the respective ethanol concentrations as shown in FIG. 12 can be pre-checked by experiments or the like and are stored in the specifying device 1500 as data. Using the relations shown in FIG. 12, the specifying device 1500 can calculate the electric conductivity of the mixed fuel based on the first output and the second output.

As described above, the connection unit 1600 of the sensor 1200 includes the switches 1610, 1620, and 1630 as a switching device configured to be able to switch between the state in which the first electrode 1014a and the fourth electrode 1012b are at the first potential V1 and in which the second electrode 1014b and the third electrode 1012a are at the second potential V2 (V2≠V1) and the state in which the first electrode 1014a and the third electrode 1012a are at the first potential V1 and in which the second electrode 1014b and the fourth electrode 1012b are at the second potential V2. The specifying device 1500 switches the connection unit 1600 between the two states to supply power to the sensor unit 1010 and measures the capacitance C in the respective states. In the state in which the first electrode 1014a and the fourth electrode 1012b are at the first potential V1 and in which the second electrode 1014b and the third electrode 1012a are at the second potential V2, the capacitance C(1) of the sensor unit 1010 increases by the capacitance Cz obtained between the electrodes partly opposite to each other with the substrate in between. A dielectric loss tan δ of the sensor unit 1010 is in inverse proportion to a product of the capacitance C and a parasitic resistance R2 of the sensor unit 1010. Thus, an increase in capacitance C reduces the dielectric loss tan δ and an adverse effect of the parasitic resistance R2 (that is, an adverse effect of the electric conductivity of the measured liquid). The capacitance C can be measured with the dielectric loss tan δ reduced, thus improving measurement accuracy for the capacitance.

Furthermore, the connection unit 1600 switches the switches 1610, 1620, and 1630 to allow the capacitance C(2) to be measured in the state in which the first electrode 1014a and the third electrode 1012a are at the first potential V1 and in which the second electrode 1014b and the fourth electrode 1012b are at the second potential V2. The capacitance C(2) decreases with increasing parasitic resistance R2. A comparison between the capacitance C(1) and the capacitance C(2) enables the electric conductivity of the liquid to be calculated. The electric conductivity obtained allows the measurement accuracy for the capacitance C of the sensor unit 1010 to be improved.

### Variation

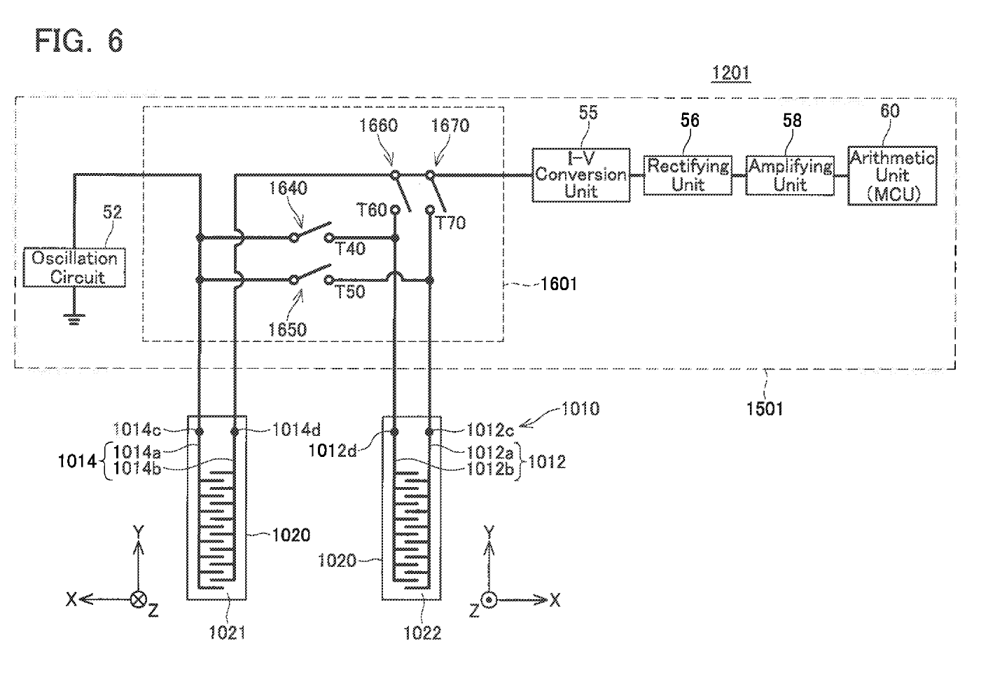

The first embodiment carries out voltage detection. However, as shown in FIG. 6, a sensor system 1201 may carry out current detection. The sensor system 1201 is different from the sensor system 1200 in a configuration of a specifying device 1501. In the specifying device 1501, the oscillation circuit 52 is connected to a connection unit 1601 without the resistance unit 54 interposed between the oscillation circuit 52 and the connection unit 1601. Furthermore, a connection unit 1301 is connected to the rectifying unit 56 via a current-voltage conversion unit (I-V conversion unit) 55.

The connection unit 1601 includes switches 1640, 1650, 1660, and 1670 as a switching device configured to be able to switch a connection state. The switch 1640 switches between connection and disconnection between the oscillation circuit 52 and a terminal T40. The switch 1650 switches between connection and disconnection between the oscillation circuit 52 and a terminal T50. The switch 1660 switches between connection and disconnection between the connecting unit 1014d and a terminal T60. The switch 1670 switches between connection and disconnection between the connecting unit 1014d and a terminal 770.

The I-V conversion unit 55 is connected to the switch 1670. A signal (voltage) at the switch 1670 is input to the I-V conversion unit 55. The voltage signal input to the I-V conversion unit 55 is converted into a current signal, which is then output to the rectifying unit 56. A remaining part of the configuration is similar to the corresponding part of configuration of the sensor system 1200 according to the fourth embodiment and will thus not be described.

As shown in FIG. 6, the specifying device 1501 connects the switch 1640 to the terminal T40, disconnects the switches 1650 and 1660, and connects the switch 1670 to the terminal 170. Thus, as is the case with the fourth embodiment, the capacitance C of the sensor unit 1010 can be measured as the capacitance C(1), which is obtained if a potential difference occurs between the electrodes opposite to each other with the substrate 1020 in between.

Furthermore, the specifying device 1501 disconnects the switches 1640 and 1670, connects the switch 1650 to the terminal T50, and connects the switch 1660 to the terminal T60. Thus, as is the case with the first embodiment, the capacitance C of the sensor unit 1010 can be measured as the capacitance C(2), which is obtained if no potential difference occurs between the electrodes opposite to each other with the substrate 1020 in between. As is the case with the first embodiment, switching the switches 1640, 1650, 1660, and 1670 of the connection unit 1601 allows measurement of the capacitance C(1), which is obtained if a potential difference occurs between the electrodes opposite to each other with the substrate 1020 in between, and the capacitance C(2), which is obtained if no potential difference occurs between the electrodes opposite to each other with the substrate 1020 in between.

### Fifth Embodiment

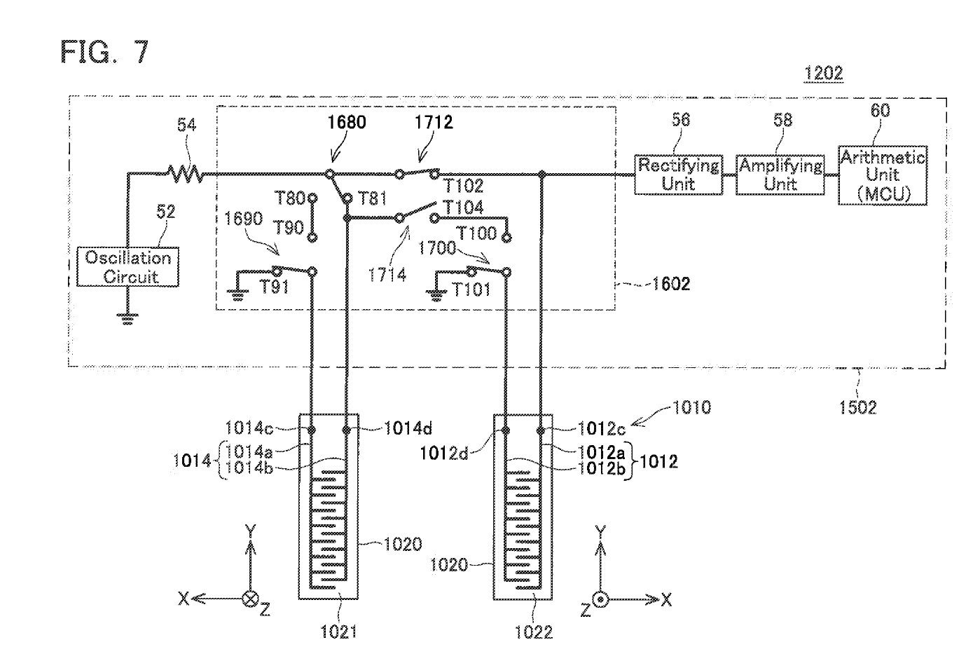

As shown in FIG. 7, a sensor system 1202 is different from the sensor system 1200 in a configuration of a connection unit 1602 in a specifying device 1502. The connection unit 1602 is configured to be able to switch between a state in which a first pair of electrodes 1014 and a second pair of electrodes 1012 are connected together in parallel and a state in which the first pair of electrodes 1014 and the second pair of electrodes 1012 are connected together in series.

The connection unit 1602 includes switches 1680, 1690, 1700, 1712, and 1714 as a switching device configured to be able to switch a connection state. The switch 1680 switches between a state in which an oscillation circuit 52 and a rectifying unit 56 are connected to a terminal T80 and a state in which the oscillation circuit 52 and the rectifying unit 56 are connected to a terminal T81. The switch 1690 switches between a state in which a connecting unit 1014c is connected to a terminal T90 and a state in which the connecting unit 1014c is connected to a terminal T91. The switch 1700 switches between a state in which a connecting unit 1012d is connected to a terminal T100 and a state in which the connecting unit 1012d is connected to a terminal T101. The switch 1712 switches connection and disconnection between the switch 1680 and a terminal T102. The switch 1714 switches between connection and disconnection between a connecting unit 1014d and a terminal T104. The connecting unit 1014c of a sensor unit 1010 is connected to the switch 1690. A connecting unit 1014d is connected to the switch 1714 and the terminal T80. A connecting unit 1012c is connected to the terminal T102 and a rectifying unit 56. A connecting unit 1012d is connected to the switch 1700. A remaining pan of the configuration is similar to the corresponding part of configuration of the sensor system 1200 according to the first embodiment and will thus not be described.

The specifying device 1502 switches between the state in which the first pair of electrodes 1014 and the second pair of electrodes 1012 are connected together in parallel and the state in which the first pair of electrodes 1014 and the second pair of electrodes 1012 are connected together in series, to supply power to the sensor unit 1010. The specifying device 1502 then measures the capacitance C of the sensor unit 1010.

As shown in FIG. 4, the specifying device 1502 connects the switch 1680 to the terminal T81, connects the switch 1690 to the terminal 191, connects the switch 1700 to the terminal T101, connects the switch 1712 to the terminal T102, and disconnects the switch 1714. Thus, a first electrode 1014a and a fourth electrode 1012b are grounded to provide a first potential V1 (0V). Furthermore, the oscillation circuit 52 applies a voltage to a second electrode 1014b and a third electrode 1012a, which provide a second potential V2 (V2≠V1=0). The first pair of electrodes 1014 and the second pair of electrodes 1012 are connected together in parallel. A capacitance Czp of a capacitive component between the electrodes opposite to each other with a substrate 1020 in between is such that Czp≠0. A capacitance C of the sensor unit 1010 is measured as C(1)=Cyp+Czp. A suffix p in Cyp and Czp represents a measured value obtained when the first pair of electrodes 1014 and the second pair of electrodes 1012 are connected together in parallel.

Furthermore, the specifying device 1502 connects the switch 1680 to the terminal T80, connects the switch 1690 to the terminal T90, connects the switch 1700 to the terminal T100, disconnects the switch 1712, and connects the switch 1714 to the terminal T104. Thus, the first electrode 1014a is connected to the oscillation circuit 52, the second electrode 1014b is connected to the fourth electrode 1012b, the third electrode 1012a is connected to the rectifying unit 56, and the first pair of electrodes 1014 and the second pair of electrodes 1012 are connected together in series. A capacitance Czs of a capacitive component between the electrodes opposite to each other with the substrate 1020 in between is such that Czs≠0. The capacitance C of the sensor unit 1010 is measured as a capacitance C(3) that can be calculated by an expression 1/C(3)=1/Cys+1/Czs. A suffix s in Cys and Czs represents a measured value obtained when the first pair of electrodes 1014 and the second pair of electrodes 1012 are connected together in series. The specifying device 1502 calculates a concentration of ethanol contained in a mixed fuel and an electric conductivity of the mixed fuel based on the capacitance C(1) and the capacitance C(3). A method for calculating the electric conductivity may be similar to the calculation method described in the first embodiment.

As described above, the sensor 1202 can measure the capacitance C obtained if a potential difference occurs between the electrodes opposite to each other with the substrate 1020 in between, as is the case with the first embodiment. The capacitance C can be measured with a dielectric loss tan δ reduced, thus improving measurement accuracy for the capacitance. Moreover, the connection unit 1602 in the sensor 1202 is configured to be able to switch the state in which the first pair of electrodes 1014 and the second pair of electrodes 1012 are connected together in parallel and the state in which the first pair of electrodes 1014 and the second pair of electrodes 1012 are connected together in series. Thus, the electric conductivity of the liquid can be calculated by comparing the capacitance C(1), measured during the parallel connection, with the capacitance C(3), measured during the series connection. The electric conductivity obtained allows the measurement accuracy for the capacitance C of the sensor unit 1010 to be improved.

### Variation

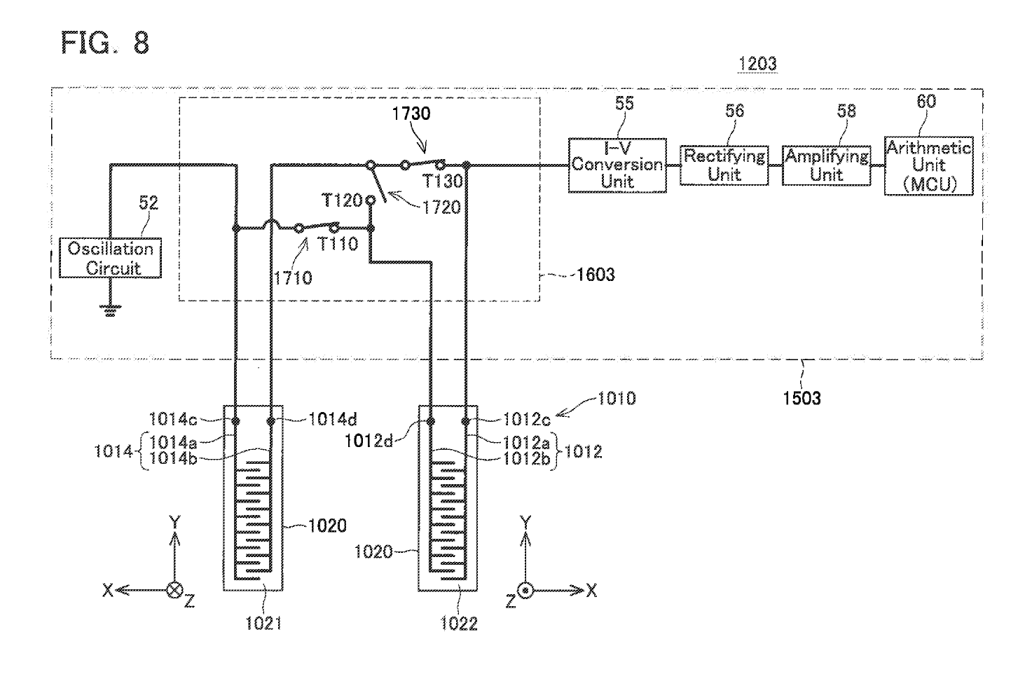

The second embodiment carries out voltage detection. However, as shown in FIG. 8, a sensor system 1203 may carry out current detection. The sensor system 1203 is different from the sensor system 1201 according to the variation of the first embodiment in a configuration of a connection unit 1603 in a specifying device 1503. The connection unit 1603 includes switches 1710, 1720, and 1730 as a switching device configured to be able to switch a connection state. The switch 1710 switches between connection and disconnection between the oscillation circuit 52 and a terminal T110. The switch 1720 switches between connection and disconnection between the connecting unit 1014d of the sensor unit 1010 and a terminal T120. The switch 1730 switches between connection and disconnection between the connecting unit 1014d and a terminal T130. The oscillation circuit 52 is connected to the connecting unit 1014c and the switch 1710. The connecting unit 1012c is connected to the terminal T130 and an I-V conversion unit 55. A remaining part of the configuration is similar to the corresponding part of configuration of the sensor system 1201 and will thus not be described.

As shown in FIG. 8, the specifying device 1503 connects the switches 1710 and 1730 to the terminals T110 and T130, respectively, and disconnects the switch 1720. Thus, as is the case with the fifth embodiment, the capacitance C of the sensor unit 1010 can be measured as the capacitance C(1), which is obtained when the first pair of electrodes 1014 and the second pair of electrodes 1012 are connected together in parallel and if a potential difference occurs between the electrodes opposite to each other with the substrate 1020 in between.

Furthermore, the specifying device 1503 disconnects the switches 1710 and 1730 and connects the switch 1720 to the terminal T120. Thus, as is the case with the second embodiment, the capacitance C of the sensor unit 1010 can be measured as the capacitance C(3), which is obtained when the first pair of electrodes 1014 and the second pair of electrodes 1012 are connected together in series and if a potential difference occurs between the electrodes opposite to each other with the substrate 1020 in between. As is the case with the second embodiment, switching the switches 1710, 1720, and 1730 of the connection unit 1603 allows measurement of the capacitance C(1), which is obtained when the first pair of electrodes 1014 and the second pair of electrodes 1012 are connected together in parallel and if a potential difference occurs between the electrodes opposite to each other with the substrate 1020 in between, and the capacitance C(3), which is obtained when the first pair of electrodes 1014 and the second pair of electrodes 1012 are connected together in series and if a potential difference occurs between the electrodes opposite to each other with the substrate 1020 in between.

### Sixth Embodiment

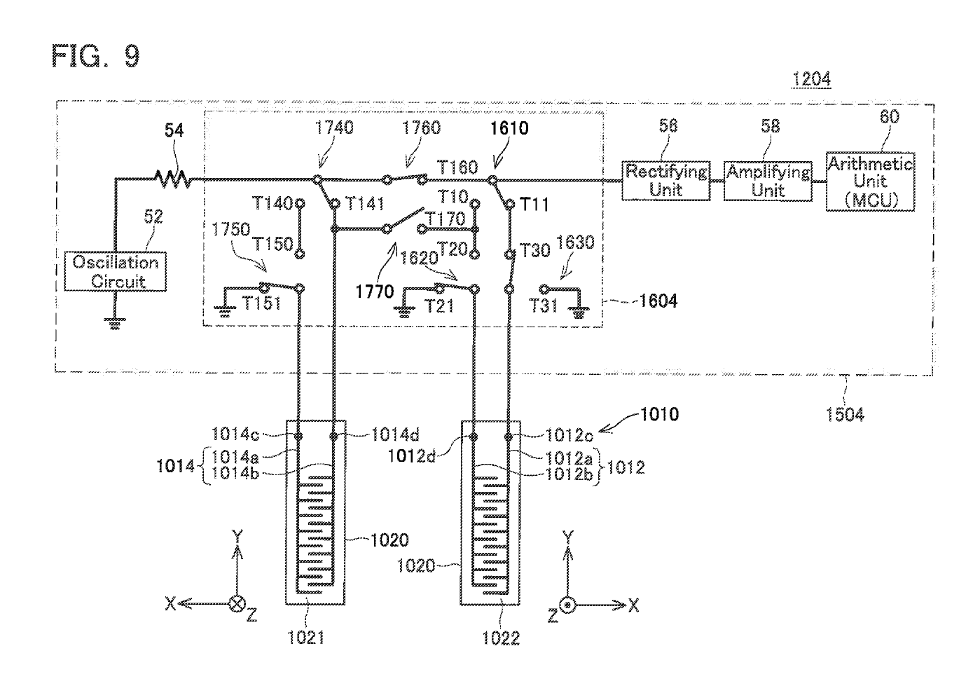

As shown in FIG. 9, a sensor system 1204 is different from the sensor system 1200 in a configuration of a connection unit 1604 in a specifying device 1504. The connection unit 1604 is configured to be able to switch between a state in which a first pair of electrodes 1014 and a second pair of electrodes 1012 are connected together in parallel and a state in which the first pair of electrodes 1014 and the second pair of electrodes 1012 are connected together in series. The connection unit 1604 is configured to be able to switch between a state in which a potential difference occurs between electrodes opposite to each other with a substrate 1020 in between and a state in which no potential difference occurs between the electrodes opposite to each other with the substrate 1020 in between, when the first pair of electrodes 1014 and the second pair of electrodes 1012 are connected together in parallel.

The connection unit 1604 includes switches 1740, 1750, 1760, and 1770 in addition to the switches 1610, 1620, and 1630 according to the sensor system 1200, as a switching device configured to be able to switch a connection state. The switch 1740 switches between a state in which an oscillation circuit 52 is connected to a terminal T140 and a state in which the oscillation circuit is connected to the terminal T141. The switch 1750 switches between a state in which a connecting unit 1014c is connected to a terminal T150 and a state in which the connecting unit 1014c is connected to a terminal T151. The switch 1760 switches connection and disconnection between the switch 1740 and a terminal T160. The switch 1770 switches connection and disconnection between a terminal T170 and a connecting unit 1014d and also a terminal T104. The switch 1610 is connected to the terminal T160. The terminal T170 is connected to a terminal T10 and a terminal T20. A remaining part of the configuration is similar to the corresponding part of configuration of the sensor system 1200 according to the first embodiment and will thus not be described.

The specifying device 1504 switches between the state in which the first pair of electrodes 1014 and the second pair of electrodes 1012 are connected together in parallel and the state in which the first pair of electrodes 1014 and the second pair of electrodes 1012 are connected together in series. The specifying device 1504 also switches between the state in which a potential difference occurs between the electrodes opposite to each other with the substrate 1020 in between and the state in which no potential difference occurs between the electrodes opposite to each other with the substrate 1020 in between, when the first pair of electrodes 1014 and the second pair of electrodes 1012 are connected together in parallel. The specifying device 1504 thus supplies power to a sensor unit 1010, and measures a capacitance C of the sensor unit 1010.

As shown in FIG. 9, the specifying device 1504 connects the switch 1610 to a terminal T11, connects the switch 1620 to a terminal T21, connects the switch 1630 to a terminal T30, connects the switch 1740 to the terminal T141, connects the switch 1750 to the terminal T151, connects the switch 1760 to the terminal T160, and disconnects the switch 1770. Thus, as is the case with the fourth embodiment, a first electrode 1014a and a fourth electrode 1012b are grounded to provide a first potential V1 (0V). Furthermore, the oscillation circuit 52 applies a voltage to a second electrode 1014b and a third electrode 1012a, which provide a second potential V2 (V2≠V1=0). The first pair of electrodes 1014 and the second pair of electrodes 1012 are connected together in parallel. As is the case with the fourth embodiment and the fifth embodiment, the capacitance C of the sensor unit 1010 can be measured as a capacitance C(1) obtained when the first pair of electrodes 1014 and the second pair of electrodes 1012 are connected together in parallel and if a potential difference occurs between the electrodes opposite to each other with the substrate 1020 in between.

Furthermore, the specifying device 1504 connects the switch 1610 to the terminal T10, connects the switch 1620 to the terminal T20, connects the switch 1630 to a terminal T31, connects the switch 1740 to the terminal T141, connects the switch 1750 to the terminal T151, connects the switch 1760 to a terminal T160, and disconnects the switch 1770. Thus, as is the first embodiment, a first electrode 1014a and a third electrode 1012a are grounded to provide a first potential V1 (0V). Furthermore, the oscillation circuit 52 applies a voltage to a second electrode 1014b and a fourth electrode 1012b, which provide a second potential V2. The first pair of electrodes 1014 and the second pair of electrodes 1012 are connected together in parallel. As is the case with the fourth embodiment, the capacitance C of the sensor unit 1010 can be measured as a capacitance C(2) obtained when the first pair of electrodes 1014 and the second pair of electrodes 1012 are connected together in parallel and if no potential difference occurs between the electrodes opposite to each other with the substrate 1020 in between.

Additionally, the specifying device 1504 connects the switch 1610 to the terminal T11, connects the switch 1620 to the terminal T20, connects the switch 1630 to the terminal T30, connects the switch 1740 to the terminal T140, connects the switch 1750 to the terminal T150, disconnects the switch 1760, and connects the switch 1770 to the terminal T170. Thus, as is the fifth embodiment, the first electrode 1014a is connected to the oscillation circuit 52, the second electrode 1014b is connected to the fourth electrode 1012b, the third electrode 1012a is connected to a rectifying unit 56, and the first pair of electrodes 1014 and the second pair of electrodes 1012 are connected together in series. As is the case with the fifth embodiment, the capacitance C of the sensor unit 1010 can be measured as the capacitance C(3) obtained when the first pair of electrodes 1014 and the second pair of electrodes 1012 are connected together in series and if a potential difference occurs between the electrodes opposite to each other with the substrate 1020 in between. The specifying device 1504 calculates a concentration of ethanol contained in a mixed fuel and an electric conductivity of the mixed fuel based on the capacitances C(1), C(2), and C(3). A method for calculating the electric conductivity may be similar to the calculation method described in the fourth embodiment and the fifth embodiment. A measured value for the electric conductivity may be an average value for the electric conductivity calculated based on the capacitances C(1) and C(2) as is the case with the fourth embodiment and the electric conductivity calculated based on the capacitances C(1) and C(3) as is the case with the fifth embodiment. This allows an accuracy of electric-conductivity measurement to be improved.

As described above, the connection unit 1604 in the sensor 1204 is configured to be able to switch between the state in which the first pair of electrodes 1014 and the second pair of electrodes 1012 are connected together in parallel and the state in which the first pair of electrodes 1014 and the second pair of electrodes 1012 are connected together in series, as is the case with the fifth embodiment. The connection unit 1604 is further configured to be able to switch between the state in which a potential difference occurs between the electrodes opposite to each other with the substrate 1020 in between and a state in which no potential difference occurs between the electrodes opposite to each other with the substrate 1020 in between, when the first pair of electrodes 1014 and the second pair of electrodes 1012 are connected together in parallel. The single sensor 1204 can carry out measurements similar to the measurements performed by the sensors 1200 and 1202, to obtain the capacitances C(1), C(2), and C(3). A comparison between the capacitances C(1) and C(2) and C(3) allows an impact of the electric conductivity of the liquid to be accurately calculated. Therefore, measurement accuracy for the capacitance is further improved.

### Variation

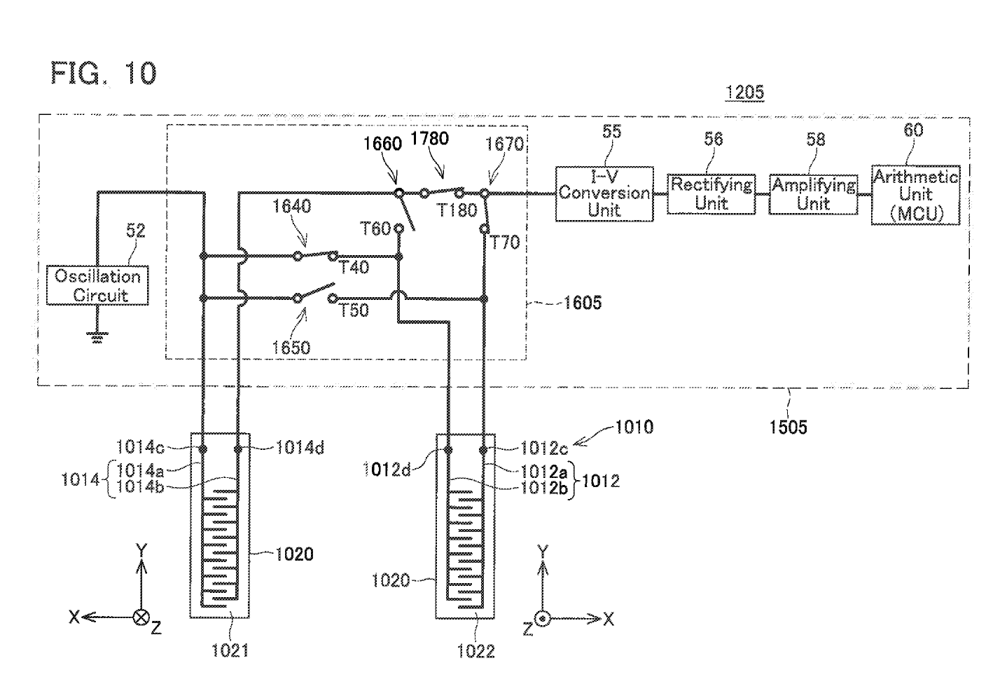

The sixth embodiment carries out voltage detection. However, as shown in FIG. 10, a sensor system 1205 may carry out current detection. The sensor system 1205 is different from the sensor system 1201 according to the fourth embodiment in a configuration of a connection unit 1605 in a specifying device 1505. The connection unit 1605 includes a switch 1708 in addition to the switches 1640, 1650, 1660, and 1670 according to the sensor system 1201, as a switching device configured to be able to switch a connection state. The switch 1780 switches between connection and disconnection between a connecting unit 1014c and a terminal T180. The terminal T180 is connected to an I-V conversion unit 55 via the switch 1670. A remaining part of the configuration is similar to the corresponding part of configuration of the sensor system 1201 and will thus not be described.

As shown in FIG. 7, the specifying device 1505 connects the switches 1640, 1670, and 1780 to terminals T40 and 170 and the terminal T180, respectively, and disconnects the switches 1650 and 1660. Thus, as is the case with the sixth embodiment, the capacitance C of the sensor unit 1010 can be measured as the capacitance C(1), which is obtained when the first pair of electrodes 1014 and the second pair of electrodes 1012 are connected together in parallel and if a potential difference occurs between the electrodes opposite to each other with the substrate 1020 in between.

Furthermore, the specifying device 1505 connects the switches 1650, 1660, and 1780 to terminals T50 and T60 and the terminal T180, respectively, and disconnects the switches 1640 and 1670. Thus, as is the case with the sixth embodiment, the capacitance C of the sensor unit 1010 can be measured as the capacitance C(2), which is obtained when the first pair of electrodes 1014 and the second pair of electrodes 1012 are connected together in parallel and if no potential difference occurs between the electrodes opposite to each other with the substrate 1020 in between.

Additionally, the specifying device 1505 connects the switches 1660 and 1670 to the terminals T60 and T70, respectively, and disconnects the switches 1640, 1650, and 1780. Thus, as is the case with the sixth embodiment, the capacitance C of the sensor unit 1010 can be measured as the capacitance C(3), which is obtained when the first pair of electrodes 1014 and the second pair of electrodes 1012 are connected together in series and if a potential difference occurs between the electrodes opposite to each other with the substrate 1020 in between.

In the above-described embodiments and variations, the case is illustrated in which the concentration of ethanol contained in the mixed fuel is measured using the capacitance of the sensor unit. However, the embodiments and variations are not limited to this case. Another physical quantity such as a liquid level in the mixed fuel may be measured. Whichever of the first potential V1 and the second potential V2 may be higher than the other provided that the first potential V1 and the second potential V2 are different from each other. Furthermore, even if the first electrode 1014a and the third electrode 1012a or the second electrode 1014b and the fourth electrode 1012b are partly opposite to each other with the substrate 1020 in between, a capacitance can be obtained by applying a potential difference to between the electrodes.

What is claimed is:

1. A sensor for detecting a property of liquid, the sensor comprising:
a substrate,
a first pair of electrodes disposed on an upper surface of the substrate, and
a second pair of electrodes disposed on a lower surface of the substrate,
wherein a capacitance of the first pair of electrodes and a capacitance of the second pair of electrodes mutually change correlatively to a same property of the liquid.

2. The sensor of claim 1, wherein
the first pair of electrodes comprises a first signal electrode to which a signal is input from outside, and a first reference electrode opposing the first signal electrode with a space in between,
the second pair of electrodes comprises a second signal electrode to which a signal is input from outside, and a second reference electrode opposing the second signal electrode with a space in between,
the first signal electrode and the second signal electrode have a same shape,
the first reference electrode and the second reference electrode have a same shape, and
a distance between the first signal electrode and the first reference electrode is equal to a distance between the second signal electrode and the second reference electrode.

3. The sensor of claim 1, wherein
the capacitance of the first pair of electrodes and the capacitance of the second pair of electrodes mutually change correlatively to a concentration of a specific material included in the liquid.

4. A sensor system comprising:
the sensor of claim 1;
a signal supplying device configured to supply a signal to the first pair of electrodes and the second pair of electrodes; and
a comparing device configured to compare a first correlation value correlated to the capacitance of the first pair of electrodes during when the signal supplying device is supplying the signal to the first pair of electrodes and a second correlation value correlated to the capacitance of the second pair of electrodes during when the signal supplying device is supplying the signal to the second pair of electrodes and to output a comparison result.

5. The sensor system of claim 4, wherein
the first pair of electrodes is configured to connect to the second pair of electrodes in parallel.

6. A sensor system comprising:
the sensor of claim 1; and
a specifying device connected to the sensor and configured to specify a property of liquid based on a signal output from the sensor, wherein
the specifying device comprises:
a signal supplying unit configured to supply a signal to the sensor,
a reference equivalent circuit configured of one or more reference elements corresponding to an equivalent circuit of the sensor, and
an arithmetic unit configured to correct the signal output from the sensor based on a signal output from the reference equivalent circuit when the signal is provided from the signal supplying unit to the reference equivalent circuit.

7. The sensor system of claim 6, wherein
the specifying device further comprises a power voltage measurement unit configured to measure a voltage of power supplied to the sensor and the signal supplying unit, and a temperature measurement unit configured to measure a temperature of the specifying device, and
the arithmetic unit further corrects the signal output from the sensor based on the voltage of power measured by the power voltage measurement unit and the temperature measured by the temperature measurement unit.

8. A sensor for detecting a property of liquid, the sensor comprising:
a substrate;
a sensor unit comprising a first pair of electrodes comprising a first electrode and a second electrode disposed on an upper surface of the substrate apart from each other, and a second pair of electrodes comprising a third electrode and a fourth electrode disposed on a lower surface of the substrate apart from each other; and
a connection unit configured to connect a power source and the sensor unit, wherein
the first electrode opposes at least a part of the third electrode via the substrate,
the second electrode opposes at least a part of the fourth electrode via the substrate, and
the connection unit connects the electrodes in a state in which both the first electrode and the fourth electrode are at a first electric potential and both the second electrode and the third electrode are at a second electric potential different from the first electric potential.

9. The sensor of claim 8, wherein:
the first electrode opposes the third electrode via the substrate, and
the second electrode opposes the fourth electrode via the substrate.

10. The sensor of claim 8, wherein the connection unit further comprises:
a switching device configured to switch between the state in which both the first electrode and the fourth electrode are at the first electric potential and both the second electrode and the third electrode are at the second electric potential, and a state in which both the first electrode and the third electrode are at the first electric potential and both the second electrode and the fourth electrode are at the second electric potential.

11. The sensor of claim 8, wherein the connection unit further comprises:
a switching device configured to switch between a state in which the first pair of electrodes and the second pair of electrodes are connected in parallel and a state in which the first pair of electrodes and the second pair of electrodes are connected in series.
